(19) United States
(12) Patent Application Publication
(10) Pub. No.: US 2002/0124109 A1
(43) Pub. Date: Sep. 5, 2002

(54) System, method and article of manufacture for multilingual global editing in a supply chain system

(75) Inventor: Barbara A. Brown, Los Gatos, CA (US)

Correspondence Address: Steve Gupta, Vice President Finance, Appareon, 1100 Island Drive, Redwood City, CA, 94065, US

(73) Assignee: Appareon

(21) Appl. No.: 09/748,539

(22) Filed: Dec. 26, 2000

(51) Int. Cl. G06F 15/16

(52) U.S. Cl. 709/246

(57) ABSTRACT

A system, method, and article of manufacture are provided for multilingual global editing utilizing a network. Initially, text is received in a first language from a first user utilizing a network. Thereafter, the text is translated from the first language to a second language. Such translated text is then transmitted to the first user utilizing the network for allowing the first user to edit the translated text. Thereafter, the edited, translated text may be sent to a second user utilizing the network.

### BACKGROUND OF THE INVENTION

The present invention relates generally to network-based supply chain systems, and more particularly to implementing an industry-specific supply chain framework.

Companies that develop and market apparel are under severe financial pressures. Retailers are demanding shorter fashion cycles, lower cost of goods and leaner inventory practices. Apparel companies would like to reduce product development cycle time, increase their flexibility and improve on-time delivery. However, they suffer from limited visibility into their globally fragmented and complex supply chain for “design-to-order” apparel products. This leads to inconsistent communications, long cycle-times, missed deadlines and high inventory carrying costs. McKinsey & Company's industry experts estimate apparel companies lose 10 to 20% of their sales due to stock-outs and up to an additional 50% of sales are marked down due to late shipments. The inefficiency of the supply chain is at the heart of these problems.

Because most apparel products are designed to order, the apparel industry's global supply chain is characterized by a highly complex web of relationships and processes that are in a continual state of flux. For each apparel product, the supply chain relationships span multiple countries, many of which are in developing world nations. There is wide variability in the structure of the relationships and business processes, not only among Brand Manufacturers, but also among divisions in the same Brand and between different products within the same division. Moreover, these relationships and processes change frequently to meet cost and quality pressures, changes in country quotas, increased seasonality, and shorter life cycles. These supply chain changes can be dramatic, such as moving manufacturing to a new country or even splitting production of the same product between two countries. Changes such as these entail not only establishing new relationships and processes, but also doing that in the context of a different language, new tariffs and transportation issues.

To date, the complexity of the apparel industry's supply chain has defied the use of anything more than the simplest of technologies—phone, fax, “Fedex” and some email. With expansion of the Internet infrastructure to the developing world, a global information technology solution becomes possible. The Internet offers a ubiquitous, low cost common communication infrastructure. This is a big step toward a supply chain solution for the wide flung relationships of apparel industry supply chains. However, there remain a number of significant technical challenges that must be addressed when building an apparel supply chain solution that will add significant value beyond the current phone, fax and Fedex.

Apparel is an example of a “design-to-order” industry. All design-to-order industries experience the same supply chain. In this type of industry, a marketing company focuses on understanding trends in the target customer market, creating brand loyalty among customers, and building brand awareness among potential customers. This marketing company specifies products that meet customer tastes and maintain brand consistency. It then contracts with a network of trading partners that provide product designs, manufacturing capacity, and raw materials. Because of economic and demographic differences among nations, marketing companies, manufacturers, and raw material suppliers typically exist in different countries, resulting in a number of communication and logistical challenges. Moreover, the underlying reason for design-to-order products is that market requirements change over time. Therefore, the marketing company and its trading partners have a limited window of time in which to complete the design-to-order process for any given product. Also, technological, economic, and demographic changes result in a continuously evolving landscape of business processes and business relationships.

Design-to-order industries exist for both hard goods and information goods. In the hard goods arena, design-to-order industries include, but are not limited to, apparel, sporting goods, home furnishings, and children's toys. In these cases, manufacturing companies turn designs into finished goods using physical raw materials, physically shipping raw materials to factories and finished goods to retail distributors. In the information goods arena, design-to-order industries include advertising, media production, and offshore software development. In these cases, production companies turn specifications into finished works using a network of information suppliers, electronically shipping information from information suppliers to production company and finished works to information distributors.

### SUMMARY OF THE INVENTION

A system, method, and article of manufacture are provided for multilingual global editing utilizing a network. Initially, text is received in a first language from a first user utilizing a network. Thereafter, the text is translated from the first language to a second language. Such translated text is then transmitted to the first user utilizing the network for allowing the first user to edit the translated text. Thereafter, the edited, translated text may be sent to a second user utilizing the network.

In one embodiment of the present invention, the translated text may be displayed to the first user on a display device for the allowing the first user to edit the translated text. To facilitate this, a virtual keyboard may displayed to the first user on a display device for the allowing the first user to edit the translated text. Optionally, the virtual keyboard may includes alphanumeric characters in the second language.

In another embodiment of the present invention, the edited, translated text may be saved. Further, the text may relate to an apparel industry.

### BRIEF DESCRIPTION OF THE DRAWINGS

FIG. 1 illustrates, rather broadly, the features and benefits of one embodiment of the present invention;

FIG. 1a illustrates a method for manipulating a sequence of a work item in a supply chain, in accordance with one embodiment of the present invention;

FIG. 2 shows a representative hardware environment on which the method of FIG. 1a may be implemented;

FIG. 2b illustrates an exemplary system architecture that may be executed on the hardware environment of FIG. 2;

FIG. 3 illustrates a method for translating documents in an design-to-order supply chain;

FIG. 4 illustrates a method for tailoring a network-based supply chain for different regions;

FIG. 5a illustrates the various software components of the present invention;

FIG. 5b illustrates a method for providing a dynamic supply chain module in a supply chain of a plurality of businesses;

FIG. 5c illustrates a method for managing participants in a supply chain;

FIG. 6a illustrates a method for workflow management of a supply chain, in accordance with one embodiment of the present invention;

FIG. 6b illustrates a supply chain workflow topology in accordance with one embodiment of the present invention;

FIG. 7 illustrates a table that summarizes the properties of workflow abstractions of the present invention;

FIG. 8 illustrates workflow processing across three levels of abstraction;

FIG. 8a illustrates the manner in which business documents are constructed in accordance with one embodiment of the present invention;

FIG. 8b illustrates a document category overview, in accordance with one embodiment of the present invention;

FIG. 9 illustrates a scheme for deriving screens from tasks;

FIG. 10 illustrates a workflow model in accordance with one embodiment of the present invention;

FIG. 11 illustrates a primary message flow among the various components of the present invention;

FIGS. 12-19 illustrate a collaboration manager hub, collaboration manager node, conversation manager initiate module, conversation manager generate module, conversation manager complete module, presentation manager initiate module, presentation manager respond module, presentation manager complete module, respectively; and

FIGS. 20-23 illustrate subsystem architecture associated with the collaboration manager hub, collaboration manager node, conversation manager modules, and presentation manager modules, respectively.

### DETAILED DESCRIPTION OF THE INVENTION

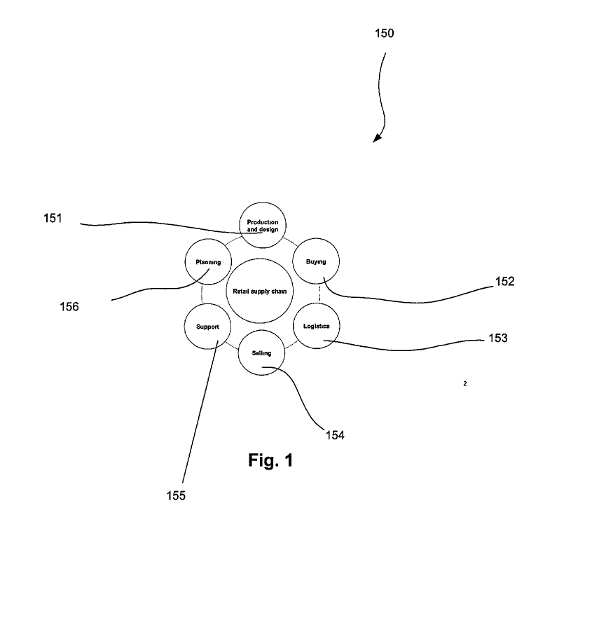

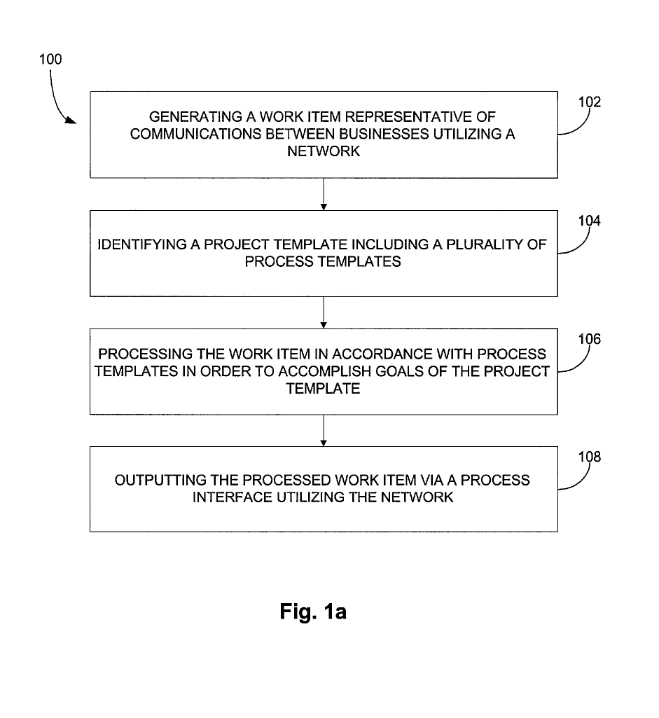

FIG. 1 illustrates, rather broadly, the features 150 of the present invention. As shown, benefits are accrued in various areas including production and design 151, buying 152, logistics 153, selling 154, support 155, and planning 156 to provide a design-to-ordersupply chain.

With respect to production and design 151, the present invention is capable of reducing lead times to produce designs, delivering products and coordinating production by improving on-line collaboration between marketing companies and designated suppliers. Further, faster communications and decisions are enabled to shorten production cycle times. Regarding buying 152, spending may be aggregated, and management of a dynamic and changing global supply market of labor rates, exchange rates, import quotes, qualified supplier base may be expanded. Further, expiring goods may be purchased on spot exchanges to deliver exceptional consumer values.

Further, logistics 153 are improved by monitoring flows of goods in real-time including negotiating with carriers worldwide in real-time. Further, selling 154 is improved by increasing inventory turns and increasing open to buy through “surplus auctions” and a more rapid/responsive chain.

Regarding support 155, overall supply chain efficiency is improved with software tools (e.g., reduced transaction costs). Further, planning 156 is benefited by providing planning tools for assortments and key items leveraging the Internet linked to purchasing services to reduce out-of-stocks.

FIG. 1a illustrates a method 100 for manipulating a sequence of a work item in a supply chain, in accordance with one embodiment of the present invention. First, in operation 102, a work item is generated that is representative of communications between businesses utilizing a network. In one embodiment of the present invention, the work item may include a document. Moreover, the document may include a plurality of manipulatable components such as blocks of business data, messages, alerts, action items, and a calendar. More information regarding such components will be set forth hereinafter in greater detail.

In another embodiment of the present invention, the businesses may be apparel-related businesses. It should be noted, however, that any type of business may be involved. As an option, the businesses may be located in at least two geographically remote locations.

A project template is then identified, where the project template includes a plurality of process templates. See operation 104. The work item is then processed in operation 106, in accordance with process templates in order to accomplish goals of the project template. It should be noted that the processing may include manipulating a plurality of entities in the work item using an enterprise object. Such entities may include organizations, divisions, people, subscribers, customers, addresses, contact information, and locales.

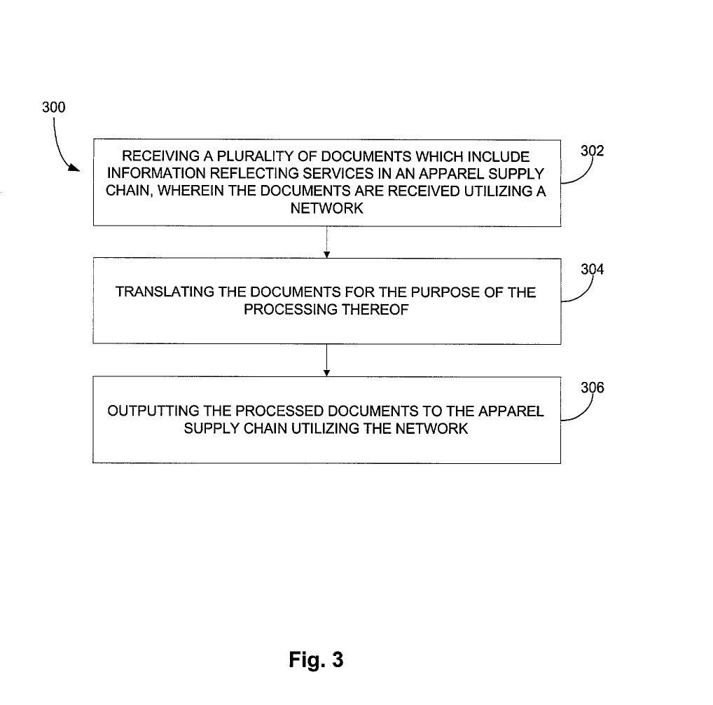

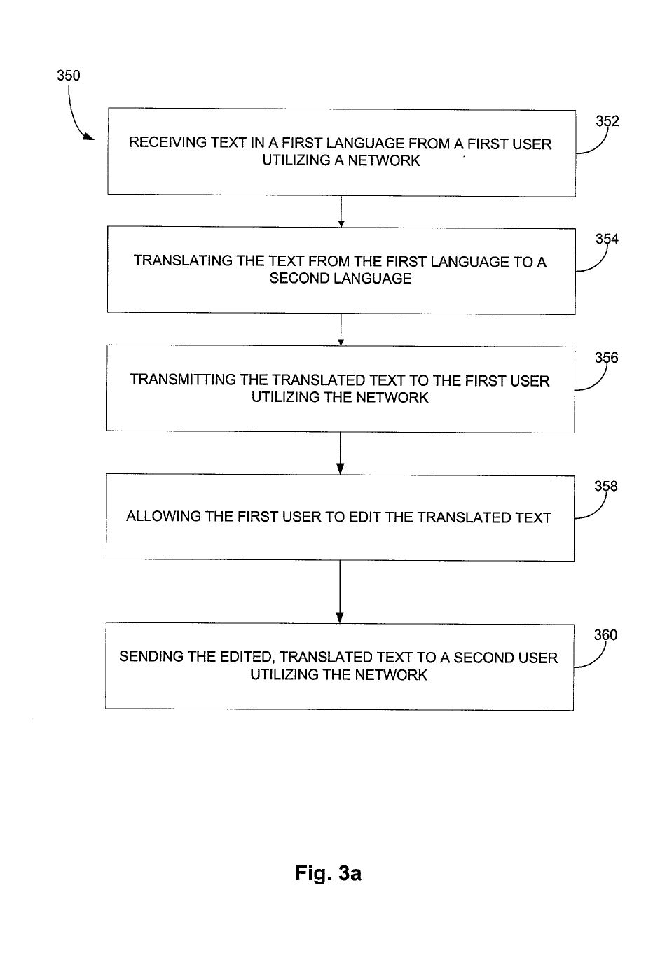

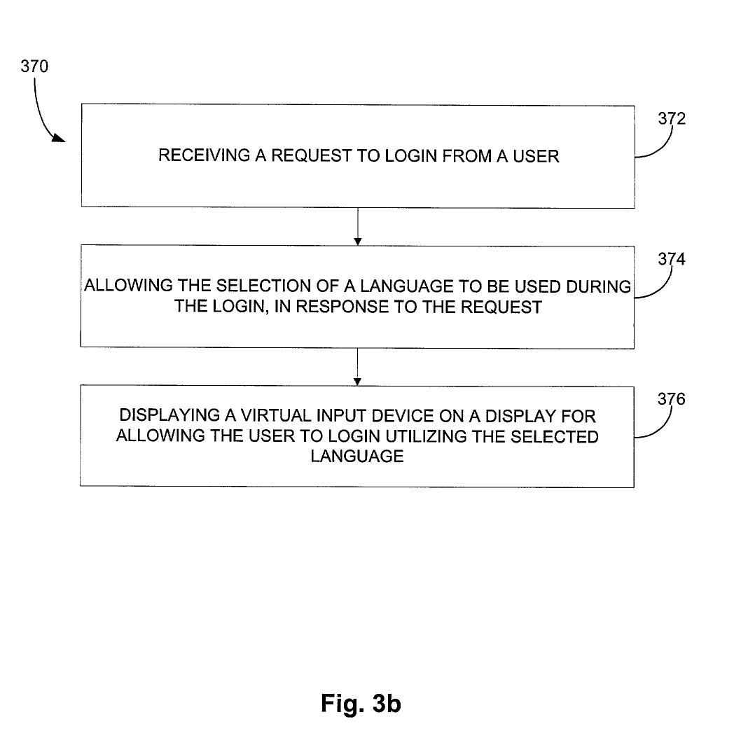

Next, the processed work item is outputted via a process interface utilizing the network. Note operation 108. Optionally, the process interface may display a representation of the processed work item in substantially the same format for each of the businesses. Additional functional features associated with the present invention will be expanded upon during reference to FIGS. 3-23.

### System Architecture

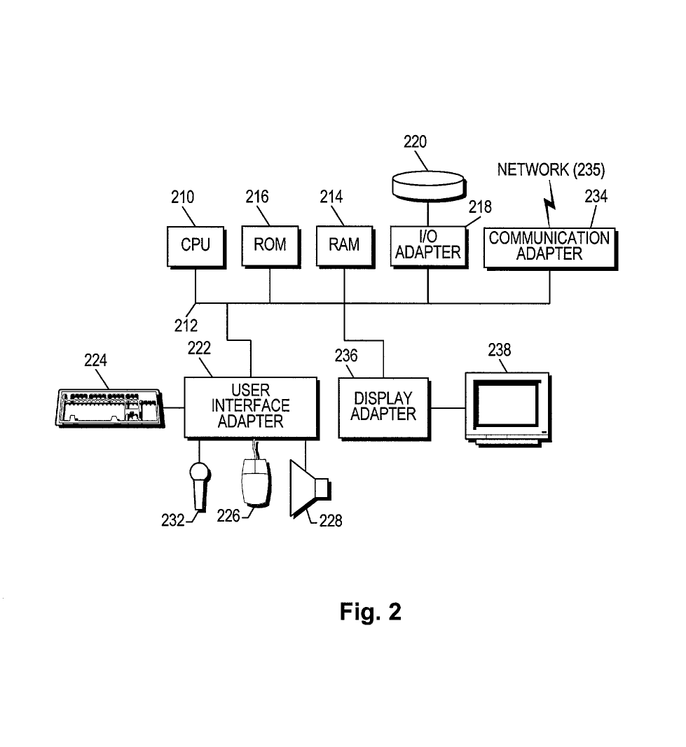

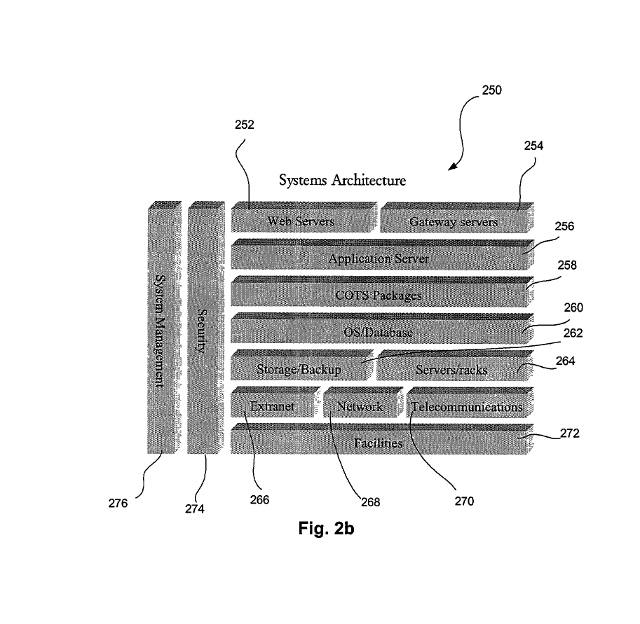

FIG. 2 shows a representative hardware environment on which the method 100 of FIG. 1a may be implemented. Such figure illustrates a typical hardware configuration of a workstation in accordance with a preferred embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation typically has resident thereon an operating system such as the Microsoft Windows NT or Windows/95 Operating System (OS), the IBM OS/2 operating system, the MAC OS, or UNIX operating system. Those skilled in the art may appreciate that the present invention may also be implemented on platforms and operating systems other than those mentioned.

A preferred embodiment is written using JAVA, C, and the C++ language and utilizes object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other. Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it may control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer may still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that one can call when he or she want those individual behaviors in a program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved.

A preferred embodiment of the invention utilizes HyperText Markup Language (HTML) pages sent over the Hypertext Transfer Protocol to present display documents to the user with a general-purpose secure communication protocol for a transport medium between the client and the server. . Information on these products is available in T. Berners-Lee, D. Connoly, “RFC 1866: Hypertext Markup Language—2.0” (Nov. 1995); and R. Fielding, H, Frystyk, T. Berners-Lee, J. Gettys and J. C. Mogul, “Hypertext Transfer Protocol—HTTP/1.1: HTTP Working Group Internet Draft” (May 2, 1996). HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML). Another document markup language and document transfer protocol such as Wireless Markup Language (WML) and Wireless Application Protocol (WAP) could substituted for HTML and HTTP without undue experimentation.

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:

Poor performance;

Restricted user interface capabilities;

Can only produce static Web pages;

Lack of interoperability with existing applications and data; and

Inability to scale.

Sun Microsystem's Java language solves many of the client-side problems by:

Improving performance on the client side;

Enabling the creation of dynamic, real-time Web applications; and

Providing the ability to create a wide variety of user interface components.

With Java, developers can create robust User Interface (UI) components. Custom “widgets” (e.g., real-time stock tickers, animated icons, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created.

Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.” One of ordinary skill in the art readily recognizes that JAVA applets could be added to or substituted for HTML without undue experimentation to practice the invention.

Another technology that provides similar function to JAVA is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for JAVA without undue experimentation to practice the invention.

A preferred embodiment of the invention utilizes data-driven computing in general and extensible Markup Language (XML) documents in particular to achieve greater flexibility in customizing system behavior than would be possible with traditional programming techniques. Even with dynamic programming technologies such as JAVA and ActiveX, customizing system behavior by altering programming language instructions requires a significant amount of software development, software quality assurance, and systems operations labor. Staff skilled in the art of software development must code such changes. They must then proceed through the compile-run-debug cycle until they achieve the desired behavior. Staff skilled in the art of software quality assurance must create a battery of tests to exercise the new behavior. They must then execute these tests, along with tests of basic system functionality often known as regression tests, to ensure system quality. Finally, staff skilled in the art of systems operations must provision the code changes from the testing environment to the operational environment. They must then make provisions for reversing the change should it cause any catastrophic consequences to the operational environment when the change first becomes active. Because of the enormous effort involved, it typically takes several weeks to implement any particular change, and updates to the system are provisioned no more frequently than once a week. Moreover, implementing the total customization of a module for a particular organization typically requires several months or more.

In design-to-order supply chains, the degree of customization and the rate at which business processes change make these time frames unacceptable. Each division or each organization needs to completely customize their modules and continually update the business processes performed by these modules as the business environment evolves. The solution to overcoming the technical obstacles to customization and rapid change is to use a data-driven computing approach. In this approach, the system designers specify a great deal of generic functionality in the system code. A set of external data specifications for each organization, division, or individual instruct the system code which functionality to apply at what times. This specification does not simply turn different features on and off. Rather, it actually affects the sequence in which the system executes code and the constraints applied to the inputs and outputs of this code.

A preferred embodiment of the invention utilized a number of data specifications to determine the work item sequencing for projects executed by multiple organizations, the work item sequencing for processes executed by multiple individuals within a single organization, and the work item sequencing of services that present user interfaces tasks to a single individual. One of ordinary skill in the art readily recognizes that one could combine data specifications into a smaller number or expand them into a greater number while preserving their semantics without undue experimentation to practice the invention.

A preferred embodiment of the invention utilizes data specifications formatted as XML documents. XML is a meta-language for specifying domain specific data formats. Because a wide variety of commercial software packages such as parsers, application servers, messaging systems, document management systems, and databases support XML, using data formats that conform to the XML specification ensures that all components of the system architecture can process the data specifications. Despite the general support for XML in these commercial software packages, the data specification for a particular data-driven application and the system code necessary to execute the instructions in the specification is highly specialized. One of ordinary skill in the art readily recognizes that one could convert any data specification formatted in XML into another structured data format such as tab-delimited files, serialized JAVA objects, or relational database tables without undue experimentation to practice the invention.

FIG. 2b illustrates an exemplary system architecture 250 that may be executed on the hardware environment of FIG. 2. As shown, various components may be included such as web servers 252, gateway servers 254, an application server 256, COTS packages 258, an OS/database 260, storage/backup 262, server/racks 264, an extranet 266, a network 268, telecommunications 270, facilities 272, security 274, and system management components 276.

### Model Complex Roles and Collaborative Processes

Many industry supply chain systems are focused on timely location and purchase of components at a good price. The core functionality of these systems is searching and purchasing from large cross-vendor catalogs. These are short-lived transactions, with a predictable, finite set of structures and business communications. Roles and responsibilities of the buyers and sellers are clearly delineated and well defined.

The design-to-order supply chain model is vastly different from this. From merchandise planning, through design, sourcing, production and logistics delivery, it involves a complex web of organizations and individuals. Many of the roles involve intermediaries as well as company employees. Moreover, the players, their roles and responsibilities differ not only among brands, but within brands as well. Finally, individual players with the same role in the process may be treated with different gradations of trust and confidence.

In addition, each design-to-order supply chain transaction is more akin to building a custom home than buying a component from a catalog. The transaction involves multiple parties and “sub-contractors”, each of whom contribute to the process over a period of many months. They have close interdependencies and a need for accurate shared information and coordination of processes. During the transaction's life cycle, adjustments such as adding new parties, changing specifications, and changing schedules can happen at any time to accommodate new opportunities and unforeseen issues.

Consequently, any supply chain solution for design-to-order supply chains may handle transactions that are long lived, nested and compensating. The solution may also be inherently collaborative. It should support multiple parties speaking multiple languages each contributing information and managing portions of the process. It should be flexible to support individual variations in roles and processes. It may bridge the disparity in document formats, allowing each party to continue using familiar formats while improving the process and ensuring accurate exchange of information. Finally, the solution should add value to the overall process by providing proactive alerts during the months long transactions.

### Add Value for All Members of the Supply Chain

The solution should add value for all parties in the chain. Since each party manages important portions of the overall process, all parties in the supply chain should be first class citizens. Each should have functionality that helps them manage their part of the process, not simply to react better to the needs of an adjacent link in the chain. Otherwise information quality is compromised.

No one member of the supply chain should dictate the solution. For example each Brand may want to define their preferred format for creating a purchase order, while each supplier may want to define the way they view purchase orders regardless of Brand format. The solution should support this need without compromising data integrity. In addition, the solution should provide information visibility across the chain in each member's preferred native language.

### Support Rapid Customization & Re-customization

Given the variability and dynamism of processes and relationships, and the lack of standard documents for communication, it is clear that no one solution may fit all Brands or all parties in the supply chain. Therefore it is imperative that any solution should be rapidly customizable to reflect the needs of all the parties in the supply chain in a first class way. In particular, the solution should allow easy customization of:

Roles, relationships, and work items and easily assign these to particular individuals.

Multiple presentations of the same type of form according to each role's needs, thus supporting all users as first class citizens.

Allow customizations to be rapidly redeployed to new parties, even in different countries with different languages.

### Support Secure Dynamic Supply Chain Expansion

Apparel brands are continually seeking new sources for production to meet the unique needs of new apparel lines, collapsing seasons, cost and quality pressures and changing consumer demand. Therefore, a supply chain solution should provide an easy way to add new members of the supply chain while maintaining a totally secure, private environment. The solution should also provide facilities to help buyers find new sources in a public community, get more detailed information about them from trusted intermediaries and then add them to their private chain regardless of their location in the world and with no disruption to operations. There should be easy fluidity between the public and private communities with no security exposures.

### Support Native Languages Top to Bottom

A problem exists that when two or more users are using the system and having a conversation across countries/regions. The users send comments to each other that stay in the language in which they are writing. For example, a Chinese user may send a comment to a user in NY, the comment will stay in Chinese and be unreadable to the US user. Further, the Chinese user cannot send English, as he/she cannot type it in using the Chinese system. Therefore, communications cannot happen.

FIG. 3 illustrates a method 300 for translating documents in an design-to-order supply chain in accordance with one embodiment of the present invention. In operation 302, a plurality of documents are received which include information reflecting services in an design-to-order supply chain. Such documents are received utilizing a network.

Upon receipt, the documents are translated for the purpose of the processing thereof. See operation 304. As an option, the documents may be translated to a predetermined language in accordance with process templates. Further, the translation of predetermined components of the information may be forbidden.

Next, the processed documents are outputted to the design-to-order supply chain utilizing the network, as indicated in operation 306. In one embodiment of the present invention, the documents may be updated in accordance with the processing thereof.

In order to operate a global infrastructure with operational centers in many countries, there is an obvious need for internationalization of key system components. However, this is not nearly enough to satisfy the unique requirements of the Apparel industry. There is a critical need to support everyone in the supply chain in their native language because of the processes and relationships that span many countries, and the fluidity of those relationships. This is even more important when many of the parties involved in the chain have little or no English skills.

Allowing each user to view and provide information completely in their native language minimizes the risk of miscommunication. Ideally native language support should apply to both structured and free form information exchanged between all the parties.

Since each party in the supply chain may choose to uniquely tailor the system, customizations should be easy to deploy in new countries with no delays in implementation. Parties should be able to define customizations in their native language, and there should be no complicated extra steps required to internationalize the customizations to work worldwide.

The present invention thus provides an internal translation engine that changes the comment from one the language entered by the sending user to the target language of the user receiving the comment. The translation occurs after the comment being sent is entered into the system. The comments in both languages are stored so the ongoing conversation is kept in both languages. The translation engine can do this between two or more languages. If the target for the comment is a plurality of users in a series of countries, the translation is done for all of them. The user sending the comment may even choose all of the target languages.

Another related problem is that real-time language translation has to be very intuitive to be accurate. Most translation engines run 80-85% accurate. Many problems may occur when a machine translation is wrong.

FIG. 3a illustrates a method 350 for multilingual global editing utilizing a network. Initially, in operation 352, text is received in a first language from a first user utilizing a network. Thereafter, in operation 354, the text is translated from the first language to a second language.

Such translated text is then transmitted to the first user utilizing the network for allowing the first user to edit the translated text. Note operations 356-358. In one embodiment of the present invention, the translated text may be displayed to the first user on a display device for the allowing the first user to edit the translated text. To facilitate this, a virtual keyboard may displayed to the first user on a display device for the allowing the first user to edit the translated text. Optionally, the virtual keyboard may includes alphanumeric characters in the second language.

Thereafter, the edited, translated text may be sent to a second user utilizing the network. See operation 360. As an option, the edited, translated text may be saved. In one example, the text may relate specifically to an apparel industry.

The present system thus allows for the user sending the communication to view the translated versions before sending. They can edit the translation by bringing up a virtual keyboard on the screen that supports the target language and editing the translation. The edited version is then sent and saved in the system. Therefore, comments can be made 100% accurate.

Traditionally, the user identifier and password to log onto a system are defined from the keyboard that the user is using when first defining these logons. A problem occurs when such user travels and still uses the global system. Unfortunately, the keyboard available to them changes, and the symbols of their personal logon are not available.

FIG. 3b illustrate a method 370 for allowing a user to login from anywhere in the world utilizing a network. First, in operation 372, a request to login is received from a user. It should be noted that the login may include entering a user name and a password, or the definition thereof. In one embodiment, the login may be conducted for the purpose of accessing a system associated with an apparel industry.

Next, in response to the request, the selection of a language to be used during the login is allowed. Note operation 374. Optionally, this selection may be automatic based on a default language and/or a current location of the user.

Further, a virtual input device is depicted on a display for allowing the user to login utilizing the selected language. See operation 376. Similar to the previous embodiment, the virtual input device may include a virtual keyboard. Further, the virtual keyboard may include alphanumeric characters in the selected language.

It should be noted understood, as an option, the request to login may be received from the user utilizing a network, and the virtual input device may also be transmitted utilizing the network.

The present system thus uses a pre-loaded virtual keyboard of all languages. Therefore, a user can bring up their original keyboard on the screen before logging in and use it for their user id/password from any other keyboard, anywhere in the world.

The present system allows the user to change the base language they work in at the time of login. When that language is chosen, not only do the user interface screens change to the chosen language, but the graphics and look and feel of the screens and workflow change to accommodate the user. For example, when a user chooses Chinese for a language, Chinese symbols will come up on the screen, the Chinese calendar is used for workflow, and the color choices to run in will be different than a United States user. The present invention also includes a pool of global symbols that can be used by all users to navigate through the system.

In another aspect of the present invention, an associated internal machine translation engine is provided to translate general conversations amongst users. A problem occurs, however, when the user is conversing in a way that is technical for a specific industry. The margin for error increases as the technicality of the comments increases.

FIG. 3c illustrates a method 380 for translating language. Initially, in operation 382, a plurality of words are received for being translated. Further, the words may be received utilizing a network, and may include technical words.

Further, a context associated with the words is identified. See operation 384. Optionally, the context may include a particular industry in which the words are used. For example, such industry may be the apparel industry.

Still yet, the words may be translated based on the identified context, as indicated by operation 386. Such translation of the words, in one embodiment, may include matching the words with a predetermined set of translated words. As an option, the predetermined set of translated words may be selected based on the identified context.

The present internal translation engine is thus customized for the verticals that the global platform supports. The engine has the decision making ability to translate technical words/phrases, translate within a particular context of the vertical, and not translate certain phrases that it knows it shouldn't. For example, a user can send a comment concerning a certain color of cloth to another user, and the engine will know the user is in the apparel vertical, that the comment being translated is referring to color, and the proper name of the color in the comment remains “as is”.

Appendix A is an exemplary portion of an international glossary for an apparel vertical market that can be used to make the internal machine translation engine accurate for the apparel vertical.

### Provide Global, Device Independent Deployment

The fundamental requirement driving global, device independent infrastructure deployment is to ensure adequate performance for every user of the system throughout the world, including the developing countries. The system must be reliable and responsive otherwise it won't be used. There are wide disparities in the quality of the Internet infrastructure, from Hong Kong—where telecommunications is world-class, to Bangladesh—where 9600 bps is state of the art, to Cambodia and Vietnam—where fax prevails, yet wireless is taking hold quickly. Consequently, user presentation should be entirely device and speed independent. Processing power should be distributed to maximize responsiveness.

These requirements drive the need to deploy infrastructure in many different regional centers. With this type of deployment a Brand is free to move manufacturing or any of its supply chain relationships from one country to the next. There should be no lag in getting a new supplier on the system with the best possible user experience.

This type of global infrastructure implies a robust and sophisticated distributed processing architecture. It should ensure data integrity, security, auditability, easy modification of business processes as they change (including full native language support), and smooth implementation of a continual stream of incremental application enhancements. Of course, all of these processing centers may be managed to provide high quality customer service and support of all the users in the supply chain.

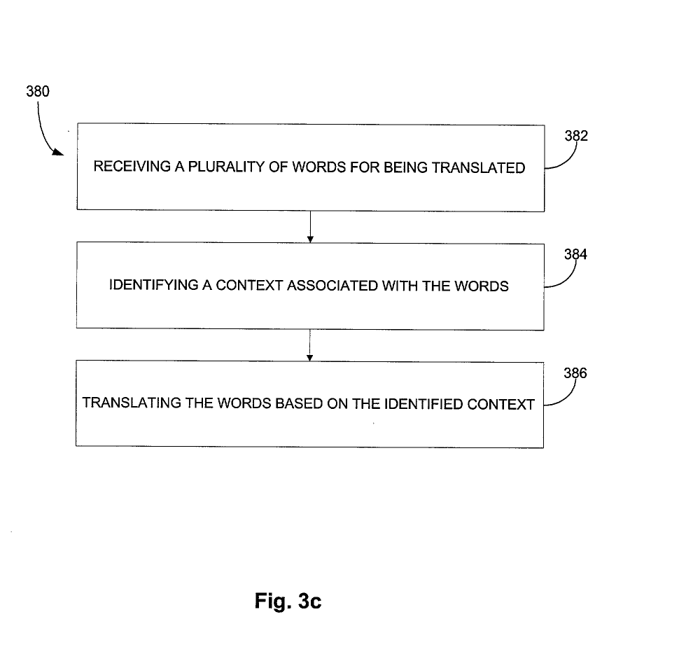

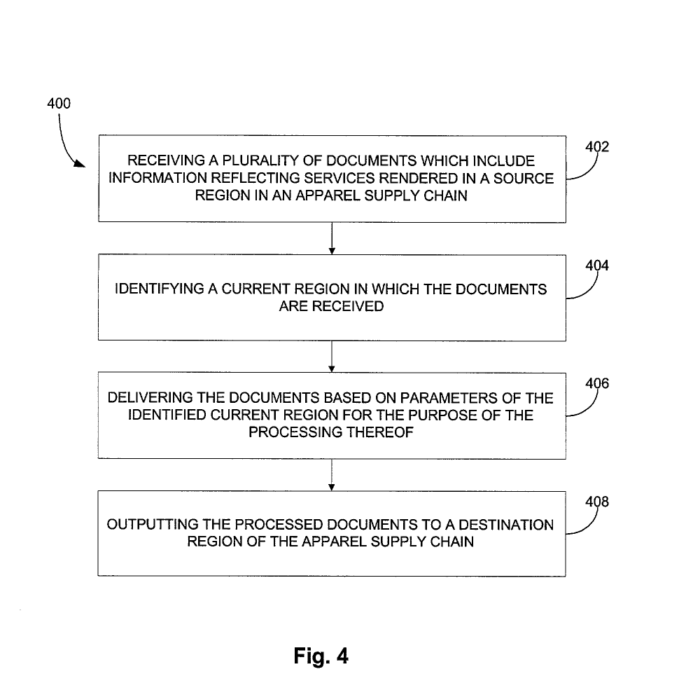

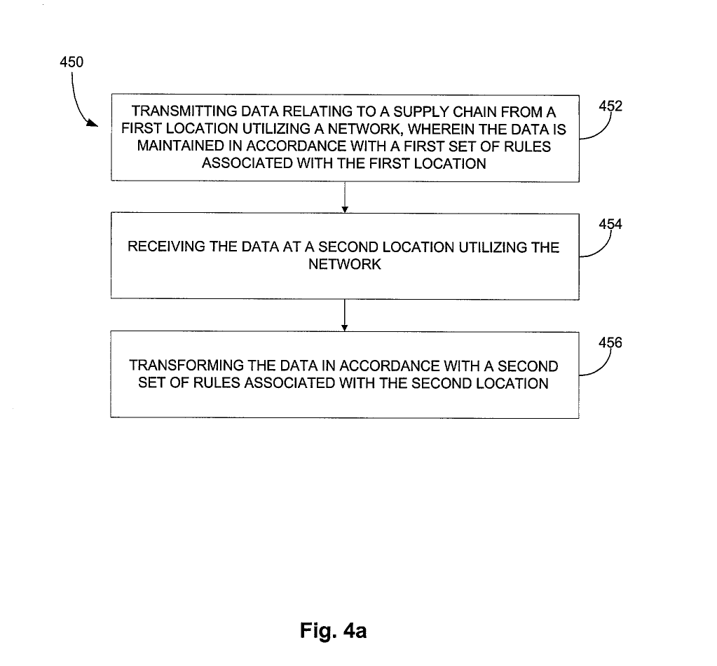

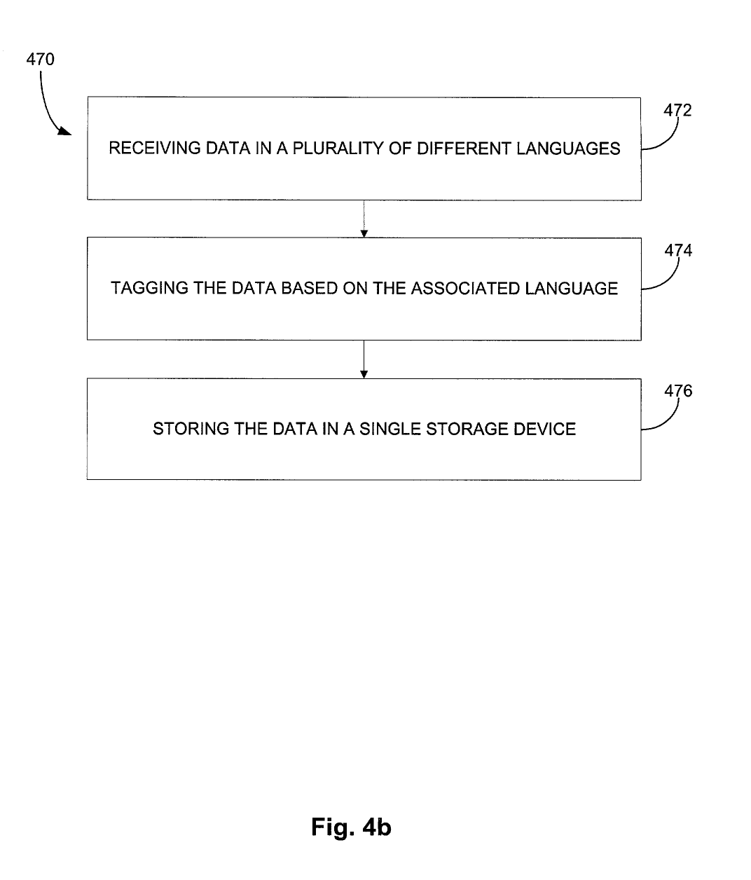

FIG. 4 illustrates a method 400 for tailoring a network-based supply chain for different regions. Initially, in operation 402, a plurality of documents are received which include information reflecting services rendered in a source region in a design-to-order supply chain.

Thereafter, in operation 404, a current region in which the documents are received is identified. Further, the documents are delivered based on parameters of the identified current region for the purpose of the processing thereof. See operation 406. In one embodiment of the present invention, the parameters may include a speed with which the documents may be transmitted, or a medium over which the documents may be transmitted. Further, the documents may be presented in a manner that fully utilizes capabilities of the current region. As an option, the documents may be translated based on the identified current region based on the identified current region.

Finally, the processed documents may be outputted to a destination region of the design-to-order supply chain, as indicated in operation 408.

The problem with a system going global is that system designs tend to be those accepted by the system originator. These designs do not take into account the laws that change between countries. This creates the problem of misunderstandings and possible system not being able to be used.

Further, problems exist with a system going global in that system designs tend to be those accepted by the system originator. These designs do not translate well across borders. This creates the problem of misunderstandings and possible laws being broken.

FIG. 4a illustrates a method 450 of handling supply chain data in different locations. First, in operation 452, data relating to a supply chain is received from a first location utilizing a network. Such data is maintained in accordance with a first set of rules associated with the first location. Note operation 454. Optionally, the rules may include laws.

Further, the data is received at a second location utilizing the network, as indicated in operation 456. It should be noted that the first location and the second location may include a first region and a second region, or a first country and a second country. Origin and destination tags may be used to facilitate the identification of the first location and the second location.

In operation 458, the data is translated in accordance with a second set of rules associated with the second location.

The present system thus takes into consideration the laws of the countries using the system in the design and provisioning of the system. Some users may have a slightly different setup and ability to handle global data differently than another countries' users, as the system is always runs according to the laws applying to IT and security of their country.

Moreover, the present system has a global infrastructure that accommodates users crossing all world borders. The system itself can detect when a user is in a country that data etc. has to be handled differently due to IT laws. For example, when a US user travels to Singapore, the data in the present system is handled according to the laws of Singapore, not the US. The knowledge that a border has been crossed and that there is change in the system that is required is handled internally to the system and not by the user. The user is working as normally he/she would work from their office anywhere in the world.

A problem further exists when a system cross languages, the data gets corrupted because the storage mixes the data up in one system. Many time in the past, system have separated the data by using separate systems or databases. These become too big or too separate to be able to scale over time and use.

FIG. 4b illustrates a method 470 for handling global data. Initially, in operation 472, data is received in a plurality of different languages. Further, in operation 474, the data is tagged based on the associated language. Optionally, the data may be tagged by allocating a file identification parameter, i.e. extension, etc. Further, the file identification parameter may be determined based on the associated language. As an option, the data may be associated with an apparel industry.

Further, the data is stored in a single storage device. See operation 476. As an option, the storage device may include a database.

The present system thus handles all global data in one system, and in one database. All data has language tags, therefore ensuring no mixing of languages and resulting in data corruption. The system remains smaller and more efficient, thereby making it able to scale in direction of adding users and in the direction of adding languages. The single, multilingual data structure is the key to allowing for this.

### Collaborative Supply Chain Service for the Apparel Industry

The present invention addresses all the supply chain solution imperatives described above by providing a comprehensive collaborative supply chain service for the apparel industry. The three inextricably linked components of the service are:

1. The Collaborative Supply Chain Platform & Solution Modules

2. A first class, 24×7 Managed Secure Global Infrastructure with regional centers around the world.

3. Partner enabling services that facilitate customization and rapid worldwide adoption of the service across the supply chain.

1. Collaborative Supply Chain Platform & Solution Modules

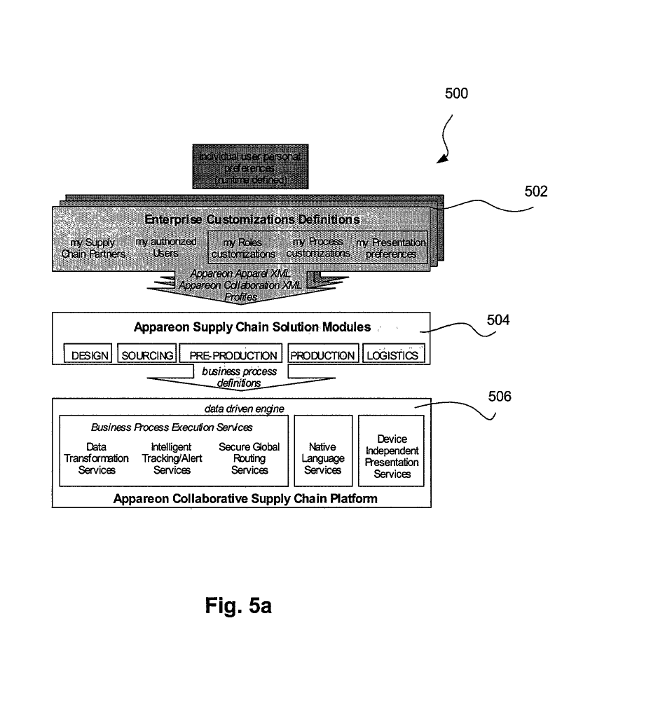

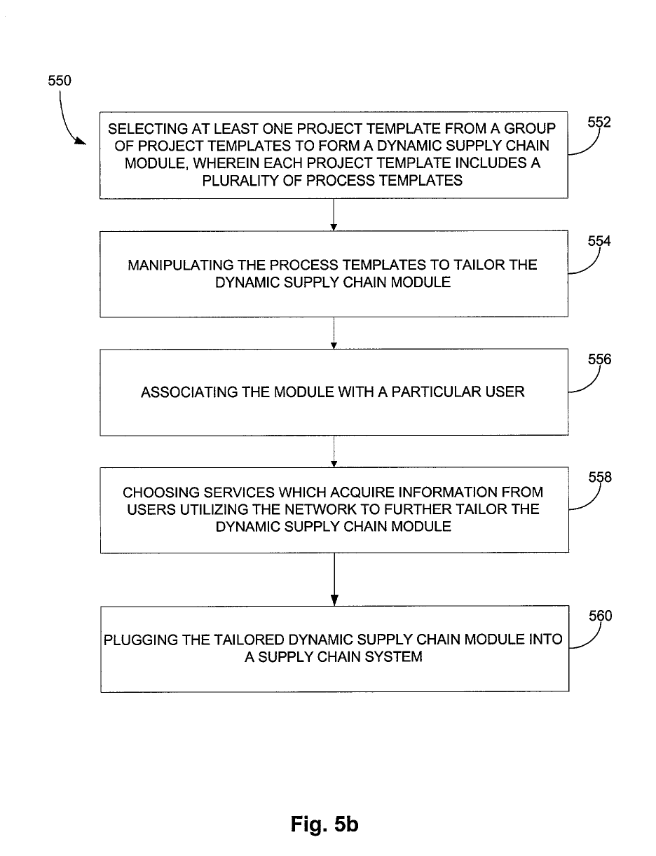

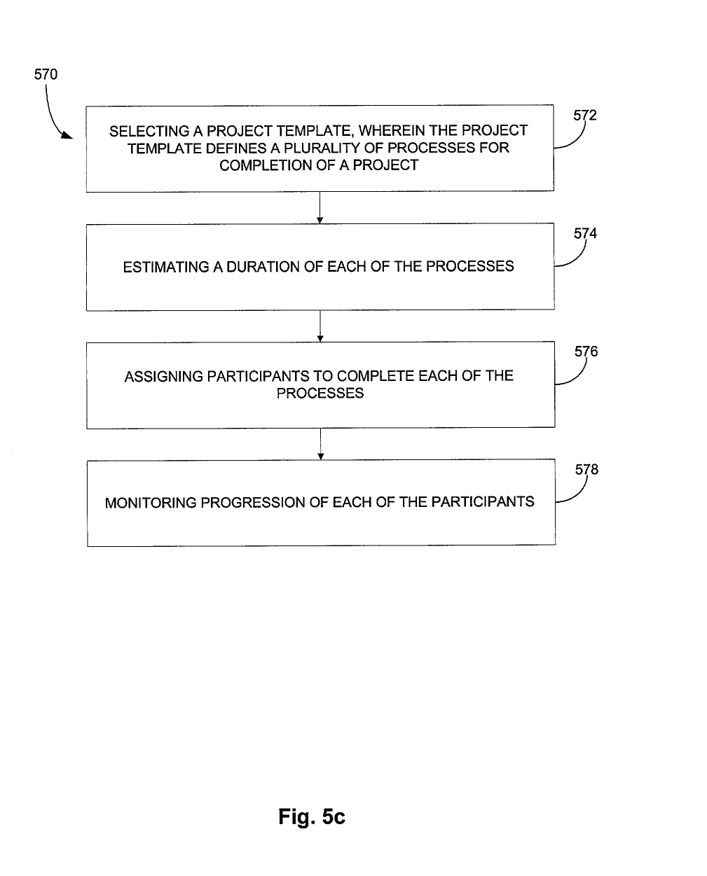

FIG. 5a illustrates the various software components 500 of the present invention.

The software component of the collaborative supply chain service consists of three major layers:

Collaborative Supply Chain Platform 502

Supply Chain Solution Modules 504

Enterprise Customization Definitions 506

The collaborative supply chain platform architecture 502 is a sophisticated fully internationalized distributed computing environment. It runs functional components on regional centers for optimum performance while ensuring full data integrity, security and auditability. The collaborative platform layer's key functional capabilities are:

Business Process execution services—a completely data driven engine which performs: user role-based business rules for data visibility and manipulation, routing, sophisticated process time tracking and analysis against defined schedules, generation of alerts, and full auditability

Presentation services—device independent, data driven presentation services. Allows each party in the supply chain to view data in best format for them, including easy expansion of user interaction to non-browser, lower bandwidth presentations, and non-landline connected devices, e.g. mobile devices

Native language services—distributed transformation engine allowing all information to be exchanged and presented in each user's chosen native language

The supply chain solution modules 504 provide all the base functionality of key business process components of the supply chain (e.g., production management, strategic sourcing). The processes' functionality takes into account the requirements of long transactions, and the iterative and collaborative nature of those transactions. Solution Modules 504 consist of:

Definition of user business roles for specific business processes (e.g., brand product manager, factory production manager) Role definitions specify data visibility and business processes that role is authorized to perform.

Data sources and processes for the transformation and routing of documents,

Data, process and schedule driven alerts.

Process tracking and reporting formats.

Default presentation formats for each of the business processes in the Solution Module.

The Solution Modules 504 are architected so that they can be progressively enhanced across the global network with no operational disruptions. This is possible because of their use of the underlying data driven collaborative supply chain platform. Moreover, because these modules are defined as data, they may be easily moved between global network nodes. This capability makes it easy to provision solution modules at different nodes in the system. It also makes it easy to move solution modules among nodes. This movement may be necessary if, for instance, a user travels from a geographic region served by one node to a geographic regions served by another node.

The third layer of the present invention is the enterprise customization definitions layer 502. One goal is to enable brand manufacturers to strengthen their supply chain relationships and enhance their business processes, not attempt to supplant or disintermediate them with a “canned” service or marketplace. Consequently, the present invention does not dictate one solution, but has built an architecture that is rapidly customizable to reflect each member's unique needs.

The enterprise customization definitions layer 502 contains descriptions of roles and responsibilities; document formats and processes unique to an enterprise in the supply chain. Since the underlying platform architecture is completely data driven, customizations do not require coding or the use of an SDK. Therefore customization is flexible and rapid. Finally, since the present invention is fully internationalized, the customization definitions can be specified in native languages, thus easing adoption and providing first class support to all parties in the supply chain.

2. Managed Secure Global Infrastructure

The best apparel supply chain software in the world may not be used unless it is reliable and provides a responsive end user experience. When supply chain partners are primarily in North America or in G7 countries this is less of a challenge. However, the apparel industry supply chain extends well beyond those boundaries into the developing world. The present invention fully satisfies this need, and may address it with the second key component of its collaborative supply chain service, its global infrastructure.

The managed secure global infrastructure consists of a number of regional processing centers in combination with a global routing center. All of the centers may be implemented as Telco class centers with robust security, system redundancy, failover technology and management, and 24×7 managed operations. Users of the present invention have first class operational and application level support from professionally staffed call centers. As appropriate regional centers may also be fully capable of supporting wireless connectivity and other unique regional requirements.

3. Partner Enabling Services

Partner enabling services facilitate successful adoption of the collaborative supply chain solution modules across the supply chain. The present invention understands the current state of technology in use is rudimentary with phone, fax, FedEx and some email. It is also understand that each Brand has a unique process. To help the Brands and their supply chain partners be successful, the present invention provides enabling Services that may move each partner from a business process analysis phase, through system customization, and end user training.

The present invention first focuses on the brand and their existing supply chain partners. The present invention provides the enabling services to both the brand and their chosen supply partners. Following that success, under the guidance of partners, the present invention proactively seeks out and enables additional supply chain partners to build a larger supply chain community. Ultimately this enabled community may provide greater flexibility for the brands to manage new as well as existing product lines. Brands may be able to find alternate suppliers, agents and other supply chain partners. Suppliers, agents and others may also be more visible to more brands, creating more balanced businesses for them.

The present invention enables a deep understanding of the unique challenges of the design-to-order industry supply chain—the complexity of the relationships, the dynamism of the business processes, the longevity of each transaction, and the reach into the developing world. All these characteristics make creating a solution that adds value a challenge. The present invention provides a comprehensive service with three inextricably linked components—a software solution designed uniquely to address design-to-order supply chain requirements, a world class managed secure global infrastructure that can reach into the developing world, and partner enabling services that facilitate customization and rapid adoption across design-to-order supply chains like that of the apparel industry.

### Objects by Category

The following section presents the types of things the present invention manipulates.

These design objects are grouped into categories to best explain what each are.

This particular sequence of the narrative flow was chosen to best describe the different categories in an order which best builds up the total picture of the types of objects in the system. However, sometimes forward references to new concepts are made along the way, that are explained later in more detail.

Each category of design objects provides an initial overview and a final summary of the main points.

The scope of the categories of things manipulated within the system are:

Document Objects

Planning Objects

Enterprise Objects

Team Role Objects

Network Objects

The sections following this describe the relationships between the objects in more detail. In addition, each of the terms described herein appear as part of the glossary of terms at the end of this document.

### Documents

The documents define the active content communicated amongst the businesses using the present invention.

All documents are part of an audit trail that records their content's activity.

The present invention may manipulate these types of active content:

Business Documents

Messages

Alerts

Action Items

Calendar

Business Documents

Business documents are legally binding documents between two parties. They flow between businesses as messages, and at rest update their respective systems of record. Each business document is a collection of data to accomplish some value added to the supply chain.

They are usually large structures with many sub-elements. Examples of business documents include a Purchase Order, Shipping Notice, and the like. Although they often have paper counterparts, business documents may be primarily electronic. They consist only of data, and are not an image or facsimile of the paper forms they represent.

Because business documents are legally binding, the definition of their contents are agreed upon by both parties. Because the relationship of the parties to a trading partner network may differ substantially across different trading partner networks, each trading partner network may have unique requirements for the information contained in its business documents. Therefore, business documents must be fully customizable for each trading partner network. Business documents may require an authorization before being forwarded from one business to the next.

Comments

Comments hold the more informal communication between two parties in the supply chain. They are brief text messages that form threads of commentary in the context of a business document's contents.

Because they are comments, they do not form part of the business document definition itself. An end user may comment about any business document at any time as a general messaging facility.

Threads of conversation form when more than one comment is attached to the same fragment of business document. The attached commentary is seen once the end user pulls the business document into view. The commentary shows the people who participated in the thread, what they said and when they said it. They are attached to the fragment of document about which they talk.

Alerts

Alerts are real-time messages forwarded when special events occur. Unlike Comments, they are pushed to the receiving party. Any party may receive an alert at any time, that is, they do not need to have the system running on the browser to receive an alert.

Alerts are brief text notifications that are routed to the receiving party's web page or email, pager, fax machine or cell phones and the like. Their purpose is to notify the receiving party to pull up the system on their browser.

The alerts are attached to their context in a business document in much the same way that comments are. By responding to an alert, the party is taken to the information to pull up on their web page to review.

Alerts can be posted by the sending party, or be the result of an event triggered within the system once a pre-defined condition is met within the process or data. These events can be fired at any time, and may cause multiple triggers. To prevent the annoyance of a constant stream of alerts from multiple sources being received on multiple devices, each notification aggregates the alerts, and is periodically routed and released by the system.

More information on Alerts is as follows:

Terminology

Instantiated—defined an instance of a type of document or task

WIP: the stage between instantiated and submitted

Submitted—submitted the instantiation of the document but it hasn't been approved by internal workflow

See Pending approval below

Published—after a task is instantiated, submitted and approved if required, it is published, which means others in the TPT can see the information on that task—even if it is empty

On the calendar—When a date is associated with a published task

Incomplete—a published task that has not been filled out and submitted by the data owner

Pending Approval: the stage between incomplete and complete or submitted and published.

Completed—once a user fills out the information in a task, submits it and gets workflow approval so that now the information in it is published.

Workflow Approval—internal approval defined in the workflow that may be given to a task or set of tasks before they can be “published” or shared with the rest of the TPT.

In one embodiment, the following types of alerts are supported:

Alerts based on the receipt of new information form within tasks

Alerts based on due dates of tasks.

When a person personalizes the system, they specify the type of alerts they want to see and how those alerts are displayed. At the user personalization level the user can modify the basic rules on a document, alert type, and role basis. All alert rules may be set at default values and at any time the user can return to those default values and rules.

The following may optionally be supported:

Modification of alert rules on a task-by-task level.

Alerts based on logic pertaining to the information within tasks.

i.e.: I can be notified if I am supposed to be done with sewing by Friday and I am not, but I cannot be notified if on Thursday I have only sewed 10 of the 100 sweaters I am supposed to sew.

Behavior and Views

It may be required to decide base level UI display and behavior for all alerts:

What information is displayed at the initial alert level and how are they differentiated.

What does one see, what can you do when they “open” them up.

What type of behavior does each have around being deleted or disappearing etc?

What type of behavior does each have around collecting like-alerts together as a document?'

What type of default rules surround who gets notified?

What types of default rules surround the type of notification—email?

The goal is to boil them down to hopefully a single or couple of categories and behaviors/appearances/“rules” and make them really simple and really easy—just like e-mail.

Alerts sent to e-mail

All alerts can be forwarded to email at the time they are sent, by the system. This option is set when a user personalizes the system. In one embodiment:

These may be simple emails, maybe with an info summary and a link—pre-coded for username and password—to the appropriate page in the present invention where the user can directly see the information they are being notified about.

The subject line of the email should be precise and clear.

The sent from address should be the individual who sent the message that generated the alert not from any “account”

As an option, the following may or may not necessarily be included in the present embodiment:

Ability to subscribe to an external email that summarizes all changes/updates and that goes out to the people in each trading partner organization that are interested and need to keep abreast of all changes but don't need to act on them on a daily basis.

Ability to forward information on the present invention—such as alerts or attached documents “blob documents”—to an email account.

Types of Alerts

Look at this Alert

A look at this message & alert is a private message between two people—it takes a visual snapshot of what the sender is looking at—it is not like delegation because the person receiving it can't complete the undone task—it's like secret work behind the scenes—it can transcend typical viewing rules—it can be used to highlight special things outside of the normal back and forth communication.—It can be a private precursor to a problem alert—it should be attached to all tasks and views of information no matter where they appear

Info Alert—New Document

Such an alert is sent the first time a new document is “published”—first time newly instantiated tasks are “published”. This may be the time that the “approval” task goes out with the document.

The people that receive the present alert may be everyone in the trading partner team that has a view role in the task. Others in the trading partner organizations will be able to see it through and they can individually set their alerts.

The present alert may have a task attached to it often times (acknowledge/accept).

Info Alert—New Task Complete

Such an alert provides a notification when new information has been added to an already instantiated and “published” task. This can be the completion of an incomplete task or the sending of a comment on an incomplete or complete task. i.e.: one has already received a “new document” alert and most likely—though not necessarily—the task was assigned a date and it was on the calendar.

The people that receive the present alert may be those who got alerted when the initial documents was “published” or routed. The new information may be completed task information or comments on a task. The alert may highlight the new information and also lets one link back into the entire document.

These alerts could get to be really burdensome if not handled correctly. One thought is to “pile them up” so that all the little things for a document collect in one alert button. Another thought is to have them be email only or not be defaulted to alert at all, or have them summarize by week across all documents and project. These probably should automatically delete as soon as they are open.

Info Alert—Approved Change Request

The present alert is used when information on an already completed task is changed and the date owner approved the change.

The people that receive the present alert may include anybody that got alerted when the initial task was completed and published.

The present alert may be very similar to the New Info alert because the person most affected by it would have already approved it. It may also be different; because a change in existing information could really change other people's offline plans.

Info Alert—Problem Notification

All problems are going to be dealt with offline through email and the system just updated to reflect the results.

Info Alert—Task Approved

The alert notifies someone that the task they submitted has been approved and published. At anytime a user can see the status of a task they completed and submitted by opening up that task in the calendar. It may read pending approval and list the approver.

To Do Alert—Task

The present alert notifies one of an approaching task that needs to be completed. In personalization, users can set the lead-time on these alerts.

The person assigned to a task may be the person that receives the present alert. If multiple people (like a whole job function) is assigned to the task, then they all may get it.

When the task as been completed and submitted, it should be removed from the alert box. If the task is started and saved as WIP the service is tagged as WIP and as a task who's due date is looming on the calendar.

To Do Alert—Rejected Task

This alert is just like a To Do Alert but it is sent after a task goes for internal approval or for external approval through a scheduled approval task and is denied. Like internal approval and change request approval tasks, a rejected task does not have a date associated with it, therefore it should be treated as if it needs to be taken care of immediately.

To Do Alert—Internal Approval, Change Request Approval

This is an alert that is set for approval tasks without a date assigned to them. This includes internal approvals (referred to as workflow approvals) and external approvals that are change requests. External approvals that have dates set to them (Approve this PO or Approve this production schedule) operate like standard tasks with dates set to them.

Some additional rules and comments regarding alerts are as follows:

One cannot “opt out” of being notified when you need to approve things—but can specify where he or she wants the alert to go.

One can only delete a To Do Alert—Approval by approving or denying the document.

These tasks appear on the calendar as a “Today's Alert” until they are completed.

Should Approval alerts stack up by document containers? Therefore if one has 3 approvals of tasks within the same document, all three may appear in the same alert.

One cannot edit information in the task he or she is approving, but can add comments or translate comments

Action Items

Action Items communicate the overall workflow within the system by scheduling specific process steps to be actioned when they are needed. The system monitors the current state of the workflow along the supply chain, and updates the agenda for each business in the system accordingly. The agenda for each business consists of a number of action items.

The action items are a brief text description of what steps can be actioned, what steps are in progress, what new steps can be launched, or what finished steps require authorization before being forwarded to the next step.

A workflow definition is used to control the updating of each business' agenda. This definition describes the logical progression of action items to update the contents of the business documents in the system as part of the flow of work.

Calendar

The calendar is the central organizing document for each of the parties using the system. Whereas a business document is for one value add activity between two specific businesses, the calendar is the visibility document used across all businesses. It is the current picture for each business of their involvement with other businesses in the system.

Like a business document, it is only a container of data, not a facsimile of a paper calendar. There are many ways to present to each business their current status within their supply chain. The dimensions for a particular calendar view may present a flow through time, similar to a Gantt chart, or be arranged around a particular business partner or document, or action item status. The calendar provides the data for the particular ways each business user rolls-up, slices and dices and filters it into views. As the central visibility document, the views of the calendar provide not only presentation graphics but also interactivity, to allow each business to launch action items from within its current view of the supply chain.

Unlike a business document, all businesses agree to use this one visibility mechanism as the contract between themselves. Nor does updating the calendar require approval from any party, it is updated as a consequence of using the business documents, commentary, action items and alerts of the system. As the system monitors the current state of all these, the calendar document for each business involved is updated real-time, whether the business is on-line to view it or not.

The purpose of the calendar is:

GUI display, access, and manipulation tool for tasks

Visual display of the time/date audit trail associated with documents and tasks throughout the supply chain.

An engine through which workday/holiday information is merged with time zone information and factored into requested and actual dates.

Possibly to serve as the engine behind sending time based alerts and reminders. Possibly serve as the engine behind each users “my page” or their customized landing page consisting of imminent tasks, other alerts, shortcuts, content etc.

Localization

Any 3rd party product used for the calendar may support local language display. It may not be necessary to support any other localize customization of the calendar (different month or week configurations, different display formats, etc.) Local conventions may be analyzed with a focus on the following:

How do the most popular computer based business calendar programs in target countries work?

What do the current calendars non-US users are marking production and testing dates on look like?

What do the calendars and planners on the most popular local wireless & PDA devices look like?

NOT necessarily what do traditional printed calendars look like.

Company-wide season calendar

Each Tier III company can set up their own seasonal calendar with milestone dates i.e.: Finish pre-production garment tests; Start cutting. However, all “milestones input through the company seasonal calendar are just that—milestones. The milestone tasks themselves have no interactivity. All interactive tasks on the calendars may be sent collaboratively between the members of the various Trading Partner Teams.

Calendar Creation

Calendars are created around “projects” (season/style). A calendar is created as soon as a style is published. The initial calendar may contain the milestone dates from the season calendar. Every time a task or roll-up task is assigned a date, the item is added to the calendar for that project.

Personal preferences calendar

This functionality may not be driven by or occur in the calendar itself. It may occur when the user is instantiating a document and may be discussed in greater detail in relation to documents and tasks.

Some calendar terminology is as follows:

“Delta dates” are the timeframes between different tasks

“Anchor date” is the starting point for those delta dates to begin calculating the actual dates

“Baseline schedule” is the template of delta dates for a particular set of tasks—normally that are strung together in a document.

In one embodiment, support may be provided for the ability to:

Save the delta dates from a schedule one is creating as a “baseline schedule” dates that he or she can use as the template for all similar sets of tasks.

Save multiple baseline schedules for a particular document type (set of tasks) i.e.: you can have one baseline production schedule for a simple T-shirt and one for a complex athletic jacket.

Populate a current set of tasks with the delta dates from a similar past set of tasks.

Keep a list of baseline schedules relating to different document types by individual users.

Support may be also provided for the ability to:

Create a custom task or reminder and to add that custom task or reminder in a personal baseline schedule that the user can invoke for other projects.

Share baseline schedules between individuals within organizations/divisions.

If so, the option may be presented to add others' baselines schedules to a personal group of baseline schedules during the initial user personalization of the system.

Example: The supplier has filled out the dates on a production schedule and gone to publish that calendar. They may be asked: Do you want to set this as you're a baseline schedule for production and do you want to use the creation date or the FOB date as the anchor date and give a name to this baseline production schedule? The next time they complete a similar production schedule (the same document) they may be asked: Do you want to populate this production schedule based on a baseline production schedule? If so, which one?

Calendar functionality

Views

Calendar views fall into two main categories:

Current View

Audit View

Each can have different views within it. Mainly the current view shows the current view of planned and actual delivery dates, while the audit view shows all proposed dates, requested changes, approved changes, etc in between. The audit calendar is designed to be used after the fact when it is time for charge backs and blame. The information traced on the audit calendar may be the fodder for data analysis and problem identification and optimization in future modules.

Tasks appear on the calendar by—at the minimum—task name. UI and usability may determine what other information is displayed and how it may be communicated.

Generally, all authorized users at organizations represented on a trading partner team can see the calendar for the team(s) they are on. In one embodiment, calendars may be viewed by projects. They can be drilled down by:

Trading partner team (this is similar to the view a garment maker would see since they are on only one team for a project)

PO

PO/FOB

Trading partner organization (this shows only the tasks that an organization needs to complete—a management view)

Individual (this shows personal tasks)

The calendar can be viewed by day, week, or month.

On the calendar one should be able to easily distinguish between tasks that belong to him or her, and tasks that belong to others.

One should be able to distinguish which tasks belong to which trading partner organizations—or at least organization types. (Agent, garment maker, textile mill)

One should also be able to easily distinguish the tasks that are past due but remain uncompleted.

One should be able to easily see the most current planned date for a task to be completed (past or future) and the date it was actually completed.

Clearly distinguish between actual tasks and milestone tasks

Audit View may or may not be entirely contained on the calendar interface. In general audit view may show the viewer the actual completion date of a task and the most recent office due date. There may also be a way to access all the other dates associated with that task, including:

Proposed dates

Original official due date

Requested changes to the official due date that weren't approved

Requested changes to the official due date that were approved

Actual completion date

As long as this information is being tracked in the database, the display portion of the information is nice to have available.

Permissions

Generally, all organizations on a trading partner team may be able to see all tasks scheduled for that team so as to maximize visibility throughout the chain (i.e.: if the logistics person can see that date after date is slipping, they can investigate backup shipping arrangements in case they are needed). However, viewing the information within the task (double-clicking) may follow the permissions contained in the task and surrounding the information within the task (i.e.: the logistics person might see that the PO was delayed by two weeks but can't see the information contained in the PO).

Functionality

Most “calendar” functionality is actually task functionality and is embedded in the rules and behavior of the task. The “calendar” just serves as one access point to that functionality.

Move between views

The most recent view of a particular project calendar is saved so next time one returns to that calendar he or she can see the calendar in that same format.

The user should be able to move between different views of a calendar.

Drag and drop for edit a task date (optional)

Follows the same rules as modifying a date in a task. Calendar just provides drag and drop GUI.

Personal Preferences Calendar

This is not calendar functionality.

View/Edit a Task (double click)

Double clicking on a task item in the calendar may open that item up.

What is displayed to the user is based on that users role in the trading partner team and the viewing permissions contained in the task relating to that role. It is not calendar functionality.

Create/Add New

Tasks may be added to the calendar through documents. In one embodiment, users may not be able to add one-off tasks to the list from a list of pre-set tasks or from a list of custom tasks that they create themselves.

Time conversion/Workday/Holiday conversion

When a date is entered for a task, that date is translated into local time for each user just like text is translated into local languages. “Local time” may factor in:

Time differences

(I requested information by Friday, but since I am a day ahead of you, you need to complete it by Thursday)

Holidays

(I requested information by Thursday but your country is on holiday that day so I really need it from you on Wednesday)

Workweek

(I requested information from you by Friday, but your work week is M-Th, Sa so I need it by Thursday)

In order to accomplish this, a standard country-by-country holiday and workweek schedules may loaded that may be applied based on country. Each user may be asked to set their local time during personalization and confirm their local workweeks and holidays.

Alerts

Alerts may be sent to the user based on the preferences they set for different tasks. The preferences may be set in the task. The calendar may be used as the “pinging” and “emailing” engine for notification but the main system may tell the calendar when to send out those alerts and where to send them.

A summary of the foregoing material on documents will now be set forth:

The system maintains a central blackboard of all these documents, and updates to each business the calendar for which they are involved.

There are formal and informal flows of documents routed both within and outside the system.

The business document flows within the system and may require authority to be forwarded as completed.

The alerts flow outside the system to page external devices as managed notifications. The notifications can re-enter the system and present the details of their alerts in context.

The commentary flows inside the system as a thread of comments about a fragment of a business document. To which fragment the thread attaches provides the context of the commentary.

The action items flow inside the system, and result from the steps taken in a defined workflow. The current agenda per user is comprised of action items.

Action items, alerts and comments are brief text messages. Business Documents are large, complex structures of data.

Plans

FIG. 5b illustrates a method 550 for providing a dynamic supply chain module in a supply chain of a plurality of businesses. In one embodiment of the present invention, the businesses may take the form of apparel businesses. Initially, in operation 552 at least one project template is selected from a group of project templates to form a dynamic supply chain module. Each project template may include a plurality of process templates.

In one embodiment, the project template may allow the businesses to engage in activities utilizing the network. Such activities each include a plurality of steps. The completion of such steps is tracked in a document.

Thereafter, the process templates may be manipulated to tailor the dynamic supply chain module in operation 554. Moreover, the module may be associated with a particular user, as indicated in operation 556. As an option, a plurality of users may be explicitly selected to interface with the dynamic supply chain module.

To further tailor the dynamic supply chain module, services may be chosen which acquire information from users utilizing the network. Note operation 558. Optionally, the network may include the Internet. Such tailored dynamic supply chain module may then be plugged into a supply chain system in operation 560. In use, the dynamic supply chain module may be used to update process components of the supply chain system.

Plan objects define the progression of the business documents through the system.

Unlike the business documents, the other forms of active content do not require planning objects, because they have simpler schemes for routing their respective messages.

Each plan object defines planning at a different level of detail within the overall workflow. The system automatically tracks and enacts the workflow they define on the blackboard.

The present invention manipulate these plans:

Project

Process

Service

Task

Project and Process Templates

A project defines an overall plan for a particular purpose.

All the business documents, alerts, action items and comments in the system are processed only within the scope of the project to which they belong. Only the calendar document contains data from across multiple projects.

New projects are created from a project template. A project template contains different combinations of process templates as a starting point for modeling the new project.

A process template is a placeholder for a type of process. Using these, the project plan can be modeled to try out ‘what-if’ scenarios using different combinations of process templates. Not all process templates need be known at the time of project creation, they can be added, replaced and removed dynamically as a project progresses.

A process template is used to create and launch a particular process. Once a process is created, it is a live process. A live process cannot be removed from the project once it is created—it can only be completed or cancelled.

As a result, each project contains a number of live processes and/or process templates within it at any one time.

The project itself is not live until at least one process has been created. The project can be completed once all the live processes within it are completed or cancelled.

Project Workflow

The project workflow is the specification of a path along which the processes can flow from the start of the project to the end. Before a live process is created in a project, its process template may be connected into the workflow line of the project.

The first process template connected into the workflow for a project connects from the project's start point to its end point. Subsequent process templates are connected between these, resulting in a graph of connecting flows between process templates. The project plan may have orphaned process templates not connected to the workflow, but all live processes may be created from a process template connected somewhere in the project's workflow.

The system uses the workflow to automatically determine which processes need to be created next once each live process has completed.

In design-to-order supply chains, there are two particular work-item sequencing challenges that defy currently available workflow solutions: work-item revision and parallel branching with recombination. In traditional workflow solutions, once a work item is completed, it is closed and unavailable for further work. Because design-to-order production is a highly collaborative process that occurs over an extended period of time, changes in the market for the product or unforeseen manufacturing constraints may necessitate design and production changes late in the process. Such changes require revising closed work items. Moreover, changes to these work items require changes in certain work items completed subsequent to the revised work item. In a preferred embodiment of the current invention, planners can declare work items that users may revise and the steps used to execute revisions. Planners can also declare the dependency of a work item on revisions in a previously executed work item and the steps for resolving this dependency. When users need to revise a previously closed work item, the system uses these declarations to guide the user through the steps necessary to make the revision and then propagates this revision to all work items that were previously executed and have a dependency on the revised work items. Once the system has guided the owners of these dependent work items through the steps necessary to resolve their dependencies, it propagates the changes necessary to achieve dependency resolution to the work items dependent on these work items. This chaining process continues until all dependencies are resolved, resulting in complete synchronization of all trading partner activities with respect to the original revision.

In addition to this work-item revision problem, design-to-order supply chains also face the parallel branching and recombination problem. This problem manifests itself where the completion of one work item results in the creation of multiple subsequent work items based on the state of the original work item. For example, supply chain business documents such as quotes, purchase orders, and invoices typically involve several line items. It is not unusual for an organization to process each of these line items individually with parallel sequences of work items, then recombine the results into a single work item once all of the parallel sequences have completed. In a preferred embodiment of the current invention, planners can declare a work item that may spawn parallel sequences of work items based on the number of data elements in a particular section of a business document. They can also declare a work item that takes the results of these completed sequences as input, waiting for each sequence to complete. When the system encounters a work item that results in parallel processing sequences, it first identifies the number of data elements in the specified section of the business document. It then creates one initial work item for the parallel processing sequence for each of these data elements. When the first parallel processing sequence completes, the system waits to execute the next work item until all of the other parallel processing sequences have also completed.

Process Threads

Once a process is created, it is appended onto the audit trail of live processes following each other. Each audit trail is a line of live processes which began at a process template at the workflow start and may reach the workflow end, or a cancellation along the way. Once cancelled, a new audit trail of processes may be begun from creating a process from a template. This begins a new thread of created processes.

Process Interfaces

Each process template defines a list of incoming business documents and a list of outgoing business documents as its interface. The process itself transforms the incoming business documents into the outgoing documents as a value-add activity in the supply chain for the project.

Should a live process create a new business document during its internal processing and pass that business document out, that type of document may appear on the outgoing list of the process interface. Should it internally create a new business document and not pass it out, then that type of business document may not be represented in the outgoing list because it does not pass it across the process boundary.

Only the types of business documents that cross the process boundary require definition as part of the process template. A type of business document can be both incoming and outgoing for a process interface. This does not mean that the same instance of the document may be updated and passed through—a different instance of the same type of business document may be output from that passed in.

Process interfaces are the process integration points to other systems. A process template can define its interface in terms of business documents adapted to other systems, as long as the business document definitions are agreed to by both parties, and an adaptor is built to translate the foreign system into the native protocol (XML). Once adapted, the process integrates into the audit trail of the project workflow of live processes.

Process Implementations

Usually, each process template has an implementation of its process defined as a set of services. These provide the ready-made implementation behind each process interface.

When a process is created, the services that comprise it are activated as part of the process workflow line. The workflow of services in each process is specified in the same way that the workflow of processes is specified in a project. The service work flow is just a finer level of planning in the system, modularized per process.

Unlike process workflow, services cannot be orphaned in the plan separately from the workflow—all services are part of the workflow graph of a process. This is because the detailed steps' potential flows within each process are not likely to change from project to project, and thus do not require interactive modeling as a plan.

FIG. 5c illustrates a method 570 for managing participants in a supply chain. In one embodiment of the present invention, the participants may be apparel-related businesses. First, in operation 572, a project template is selected which defines a plurality of processes for completion of a project. A duration of each of the processes is then estimated. Note operation 574. Further, in operation 576, participants are assigned to complete each of the processes. Progression of each of the participants is subsequently monitored, as indicated in operation 578. As an option, the estimated duration for a process may be compared to an actual time of completion for adjusting times associated with subsequent processes. Further, a document may be created upon termination of each process for generating an audit trail.

Further, an action item may be sent to one of the participants for providing information about the process associated with the participant. Such information relates to at least one of a date of initiation of the process, a date of termination of the process, and a duration of the process.

Process Planning

Each process provides a number of services, each of which require estimates of their duration and assignment of their resources during creation. Each process requires planning during its creation. Each processes' plan provides the information for generating action items in the system, processing all documentation routing and the formation of teams of resources to carry out a process. When a process is created, it may undergo planning before it becomes live.

Before a process is created, each of the types of business documents in its template interface definition define a set of roles by which they may be processed. The combined roles required by a process template constitutes the list of roles to which actual people can be assigned during creation of a live process. The combined list of all people assigned to a live process constitutes the process team for the business documents it processes. All the people assigned to roles across all the live processes in a project make up the current trading network for that project.

Planning also involves base-lining the expected path through services in the workflow. The work flow provides the potential paths, but the planner expects only one linear path through the workflow. By base-lining the expected path, the estimated durations of the services are accumulated and the base-line due dates for completing the expected services are calculated once the process is started.

The base-line of the expected path can report deviance from the path within the process, and provide the information to track actual dates against those estimated. In addition, the duration of each live process as a whole is the sum of the current expected path along each process thread.

The services executed as part of the workflow within each live process provide the detailed audit trail data recorded against the process thread.

The planning for each process—setting the expected base-line, the assignment of people to roles and the service durations—can be changed during execution of a live process. However, the types of business documents and their roles are fixed at creation of a live process, due to the contractual constraints underlying each business document.

Process planning may involve the same work item revision and parallel branching and recombination used during project planning.

Service Routing

In practice, services can be broadly categorized into two types of service—updates and authorizations.

Authorization services usually have two outgoing flows from their service—an accept and a reject flow. The reject flow is never part of the expected path, and is recognized as a special type of flow as a convenient idiom of the system. Hence, any reject flows are automatically excluded from planning the expected path.

Update services usually flow into an authorization service, or are routed to the next service along a conditional flow based either on values obtained during updating, or the state of the planning information about that service.

Services can route themselves through the workflow within a process based on conditional information. The default routing is always to keep following, or attempt to join, the expected path along the current set of base-lined services unless the current path, or a specified condition, prevents this.

Action items provide the means to activate or re-plan services. All the members assigned to the processing team whose role matches the entry criteria for a service are provided an action item on the calendar if it is part of the current agenda. The current agenda comprises all the services in a process thread which can be activated as the next step. The action item can indicate if the service has strayed from the base-line in the work flow, or if the service has already, or is estimated to have, strayed from the original schedule of dates calculated from the original or revised base-line.

Services can be activated by any process team member who belongs to a role that matches the service's entry criteria. Once activated, only the activator can process that service until it is completed, or cancelled. Activated services atomically exclude other team members from processing the same action item at the same time.

Task

The last types of workflow within the system is the specification of the flow of tasks within each service. This defines the atomic level of workflow in the system. The graph of tasks within a service are arranged much like the service workflow within a process.

Unlike services, tasks do not have an expected path or duration. They are not tracked against the schedule until the service is completed or cancelled.

Instead, the routing between tasks is to provide interactive editing of business document content in a guided sequence. The guided sequence steps the end user though the business document data, displaying the appropriate contextual information and providing appropriate forms for updating the data.

The service's workflow provides sets of tasks to be made available for activation at any one time, depending upon the current state of the service. The guidance ensures that only those sets of tasks relevant to the progression of tasks within a service are available at any one time. Although the inactive tasks may be visible, they are not activated for input until the appropriate place in the workflow.

Each task exclusively belongs to one set. The current set of activated tasks provides the service state at any one time. Determining the next set of tasks to activate in the flow may use conditional information from the set of tasks last activated. In addition, the validation of end user input from the current set of tasks may not allow the current set to advance to the next if invalid data has been entered. This validation can be performed and enforced on the client and/or server end.

The service state can be elected to be undone by the end user to a former service state. The history of service states activated by the end user is kept in a sequence, and an un-do action rolls-back the current state to a former state. In addition, the service can be atomically cancelled at any time. Only the service states that flow into the service end point allow the service to become complete.

While a service is activated, its action item indicates to the activator end user that it can be resumed for processing.

Upon completion of a service, the sequence of service states are added as detail to the service audit trail within the process thread.

A summary of the foregoing material on plans will now be set forth:

Work flow relates to the transformation of business document data.

The system specifies workflow at different, specialized levels. Despite this layering, all workflow is consistently recorded for audit.

A project can be started although its final definition is still incomplete.

Planning of all resources and time is required at process creation. Re-planning of any of these can occur at any time subsequently.

Project workflow is across process boundaries. Each process can use the present implementation comprising a number of pre-defined services, or work can be planned to flow through the process interface of external systems.

As processes are created from the project start state, a process thread of the live processes is begun as an audit trail to follow all the live processes passed through until the project end or cancellation.

The process templates are linked into a workflow graph. This same idiom of workflow graph linkage is carried into the service and task levels.

The expected path through the services for each project template is base-lined as a straight line through the graph of services. The expected path can be modified away from the base-line at any time.

Action items per end user overlay the set of all services in a project to present the planning status of each service in a calendar view.

Only people with a role that is defined as part of the service entry criteria can activate a service. Once activated, the service is unavailable to others until completed or cancelled.

Task work flow progresses the end user through a sequence of task set steps.

Enterprise Objects

The present invention manipulates these entities:

Organizations

People

Subscribers

Customers

Addresses

Contact Info

Locale

Team Roles

The present invention manipulates these entities:

Permissions

Privacy

Assignment

Teams

Delegation

Project Manager

Team Manager

Routing by Role

Network Objects

The present invention manipulates these entities:

Browsers

Adaptors—data, process

Devices

System Capabilities

The following feature list of the system is categorized into broad areas of capability.

Routing Capabilities (messaging in context, aggregated)

Authorization Capabilities (logon authentication)

Editing Capabilities (resume, undo, follow me)

Support Capabilities (asking for support in context)

Scheduling Capabilities (date changing and visibility)

Translating Capabilities (international)

Contractual Capabilities (audit, document authority, archive)

Customization Capabilities (aggregation, customization, standards)

Database Capabilities (transactional, data point addressing, dm1 editing and tracking)

Data Integration Capabilities (batch, trigger, adaptors)

Process Integration Capabilities (interface, implementation)

Application Meta-Model

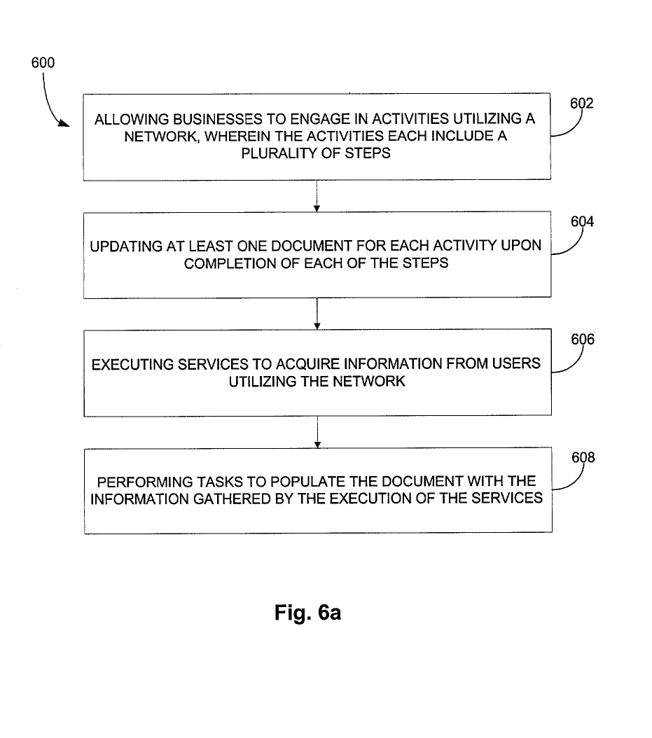

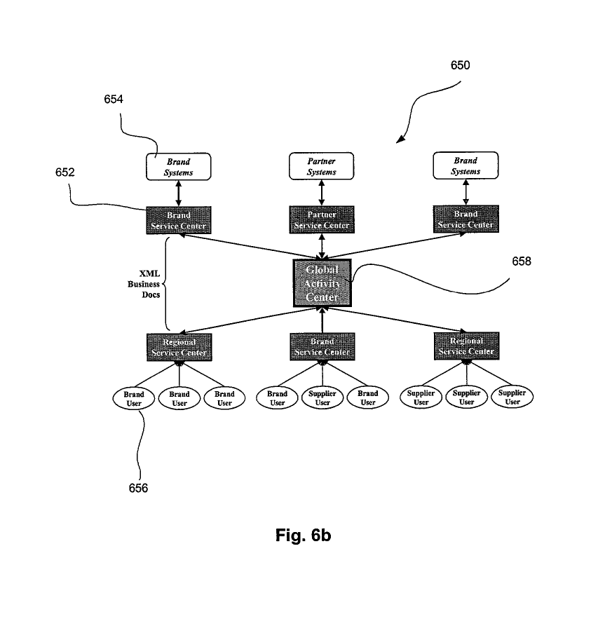

FIG. 6a illustrates a method 600 for workflow management of a supply chain, in accordance with one embodiment of the present invention. During use, businesses are permitted to engage in activities utilizing a network, as indicated in operation 602. Such activities each include a plurality of steps. Because projects and processes follow substantially the same rules, the only differences being that processes are limited to steps executed by individuals within a single organization, this description uses the term “activity” to represent both projects and processes. In one embodiment of the present invention, the businesses may be apparel-related businesses.

As the activities are being carried out, at least one document is updated for each activity upon completion of each of the steps. Note operation 604. Further, the document may provide an audit trail of the associated activity. As an option, the document may be published after the services are executed in order to allow the users to initiate the performance of the tasks.

In operation 606, services are executed to acquire information from users utilizing the network. As an option, only a single user may be allowed to execute a service at a time. Still yet, tasks are performed to populate the document with the information gathered by the execution of the services. See operation 608.

Optionally, contracts may exist which are associated with the various steps of the activity. The completion of the steps may thus be enforced utilizing the contracts.

The present invention has three sequential business goals: (1) deploy a supply chain management application for the retail apparel industry, (2) add new features to this application on a continuous basis, and (3) extend this application to support supply chain management in other design-to-order industries. Rapidly accomplishing each goal is a key factor in the success of the present invention. Accordingly, an application meta-model has been developed that supports this time to market requirement in the following ways:

Rapidly implement application features based strictly on use-cases and data models.

Factor logical application functionality in parallel with implementation of features.

Partition physical application components in parallel with implementation of features.

Specify a common application infrastructure for the entire set of features.

In the future, enable the generation of application features based on use-cases and data models.

The meta-model specifies a template for implementing application features. It is more than merely a guideline. It provides the context for unambiguous implementation based on specifications. However, it is acknowledged that complete coverage of all possible features is unlikely, thus it is expected that some implementation details beyond those derived from the meta-model.

B2B collaboration requires workflow management. Traditional workflow provides a simple and flexible set of abstractions. Each business process has a network of steps with a single start step and a single end step. With the exception of the start and end step, the steps within a workflow are of the same type. They may connect to any other step and may produce any type of output.

While flexible, traditional workflow does not provide much structure. Therefore, implementing traditional workflow systems consumes a great deal of time. It is believed that, by imposing additional constraints on the workflow used to express B2B collaborations, it can greatly reduce the time required to change existing workflows or implement new ones. In the meta-model, the following three abstractions are utilized:

Activities. Participants in a B2B collaboration conduct an activity, such as sourcing production, to perform an economic exchange. An activity is isomorphic to the traditional workflow concept of a process, consisting of many steps. But in this case, the output of a given step is a business document that becomes part of the input to the subsequent step. These business documents flow among the parties to the exchange, making activities the fundamental units of collaboration in the meta-model. As an activity proceeds, the completed business documents represent the accumulated business state. When an activity reaches its final state, these business documents comprise a complete audit trail of the collaboration.

Services. A participant in a B2B collaboration utilizes a service, such as Respond to RFQ, to create a business document within the context of an activity. A service is a specialized sub-process within an activity. Services typically occur sequentially within an activity, with some services being optional. The specialization constraint on a service is that only a single participant can utilize a given instance of a service. The goal of a service is to acquire the information from users representing a participant in order to construct the prescribed business document. A service has transactional state; it is either committed or it is not. Once a participant finishes utilizing a service, he commits the business document. The system managing the activity then publishes this document to other participants who then utilize another service to create the next business document defined in the activity.

Tasks. A participant in a B2B collaboration executes a task, such as Select Material, to provide a logical unit of information necessary to populate a business document. A task is a step within a service. Therefore, users representing a single participant execute all tasks within the same instance of a service. Tasks converge to a single end-task. A task has conversational state; until the participant commits the entire service, the state of each task may change. Once a user representing a participant completes a task, the system managing the service moves him to the next task. The accumulated state of all the tasks within an instance of a service provide the information necessary to populate the prescribed business document.

The meta-model offers a number of advantages over both traditional workflow and three-tier system architectures. First, the contracts between activity steps are all of the same type and easy to enforce. They are business documents represented as XML document types; validating the XML document with an off-the-shelf parser enforces the contract. Second, there are built-in checks and balances in the data modeling. User task analysis provides one model of the information necessary to populate a business document, while business process analysis provides a second model of what a business document contains. Finally, the meta-model provides another dimension of application partitioning beyond presentation layer, business logic layer, and data processing layer. The activity-service differentiation makes it possible to distribute complete vertical slices of functionality based on the types of participants that access a given node.

FIG. 6B illustrates a supply chain workflow topology 650 in accordance with one embodiment of the present invention. As shown, a plurality of service centers 652, i.e. brand service centers, partner service centers, regional service centers, etc., are interfaced with a plurality of systems 654, i.e. brand systems, partner systems, etc., and brand users 656. A global activity center 658 works to manage the service centers 652. It should be noted that the various service centers may include service engines, an activity router, etc.

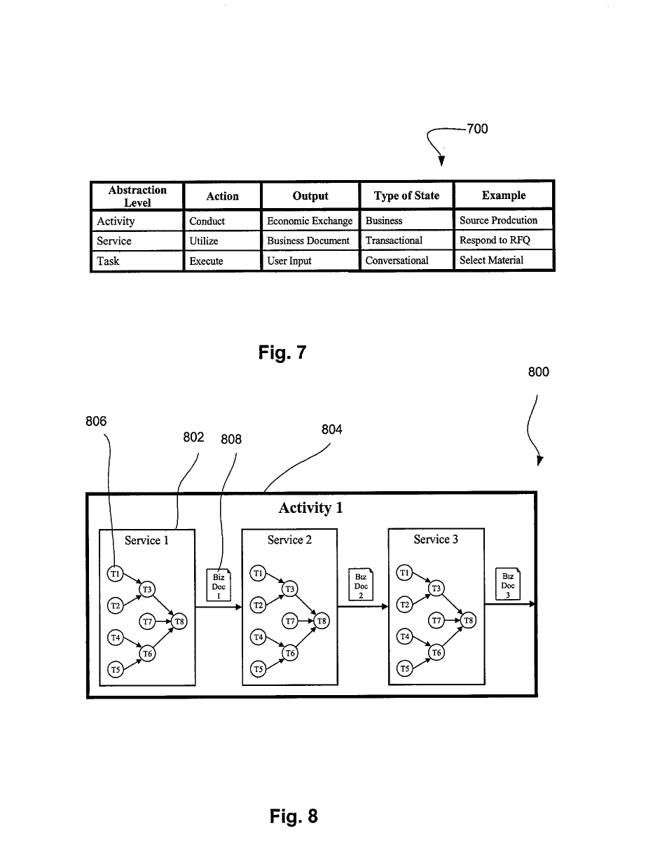

FIG. 7 illustrates a table 700 that summarizes the properties of the meta-model's workflow abstractions. As shown, actions, outputs, state types, and examples are provided for various abstraction levels, i.e. activity, service, and task.

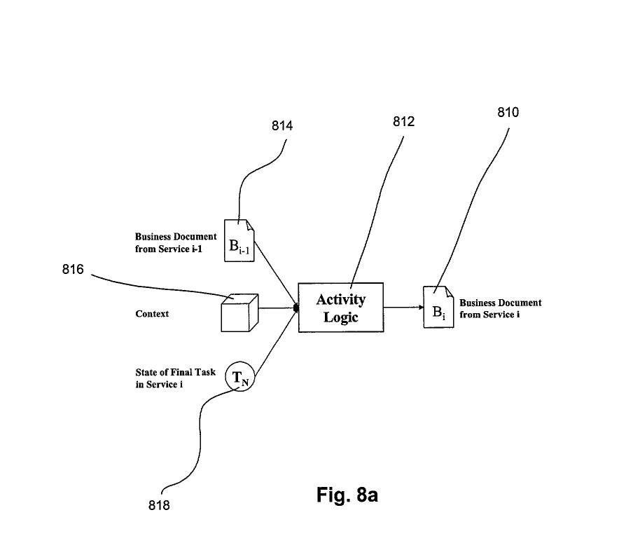

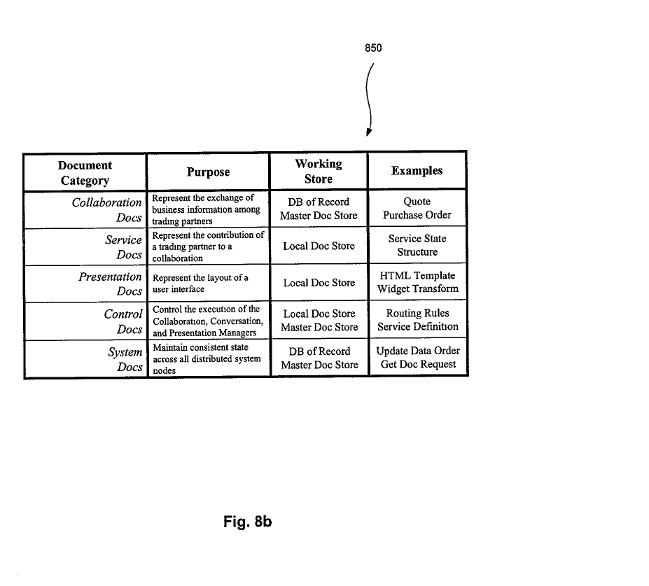

FIG. 8 illustrates workflow processing 800 across the three levels of abstraction. As shown, a plurality of services 802 are shown under a single activity 804. Such services 802 each include a plurality of tasks 806 which are executed. A document 808 is used to track progress between the services 802 of the activity 804.

One of the most difficult and error-prone facets of developing large-scale workflow systems is specifying how to derive the outputs of a given step from its inputs. The difficulty arises out of the fact that, in traditional workflow, the inputs and outputs may be anything. Therefore, in the meta-model, the types of inputs and outputs have been severely limited. If one can achieve sufficient generality to represent a wide variety of B2B collaborations with a small number of input and output types, such a user can rapidly implement high quality collaboration applications. Because two levels of process steps are utilized, activities and services, one may have data abstractions for each.

Business Documents

FIG. 8a illustrates the manner in which business documents 810 are constructed in accordance with one embodiment of the present invention. As shown, business documents 810 are generated utilizing activity logic 812 having a variety of input. For example, such input may include a business document 814 from a previous service, a context 816 in which the business document 810 is being generated, and/or a state 818 of a final task associated with the service.

Business documents are the data abstraction for the activity layer. All service inputs and outputs are business documents. A business document is a type of XML document. Through business process modeling, the requirements of a business document are analyzed for a given activity step and construct a corresponding XML schema. Because business documents represent an artifact that may cross participant boundaries, business experts serve as the arbiter of what comprises an appropriate business document rather than users in general.

The output of business process modeling may be a series of XML document types, one for each service in the activity. At an abstract level, a service implements the transition from one document type to another. As set forth in FIG. 8a, one can postulate that a given service may derive the contents of its output document from data in the following sources:

Previous Business Document. Both the input to and the output from a service are business documents. Therefore, it is likely that some of the data in the output document may be derived from the input document. For example, the Ship To element of a Quote document would be populated directly from the Ship To element in the corresponding RFQ document.

Context. No collaboration occurs in isolation. There is always some context. One proposal is to explicitly take this context into account. Context includes preferences specified by the participant utilizing the service, such as always to request payment terms of net 60 days. Context also includes, implicit or conventional behavior such as automatically defaulting to a variety of sizes for certain types of apparel orders. Finally, context may include exogenous parameters such as time.

Tasks. The accumulated user interaction from all tasks within a service clearly provides most of the interesting data for populating a business document. In fact, many of the acquired elements may probably transfer directly to the business document. Therefore, the next section further expands the details of acquired data.

In many cases, the elements of the output document may come directly from one of these sources. But there may be some transformation of the source information before it goes into the output document. There may even be complex derivation functions where several pieces of source information yield a single output element. In the first version of the system, it is proposed to use the concept of a derivation function as a means to document service implementation requirements. However, in the future, one could actually generate the implementation from a high-level derivation grammar. FIG. 8b illustrates a document category overview, in accordance with one embodiment of the present invention.

User Interaction

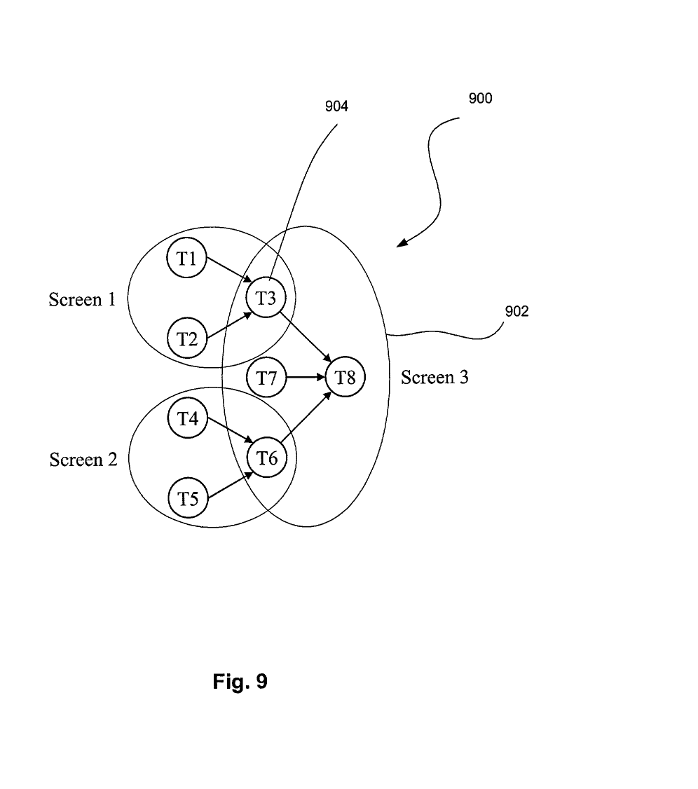

FIG. 9 illustrates a scheme 900 for deriving screens from tasks. As shown, various screens 902 may be used to represent certain combination of tasks 904 which are being executed.

User interaction is the data abstraction for the service layer. All task inputs and outputs are user interactions. A user interaction is the capture of user input based on presented information. Through user task modeling, the requirements of a user interaction are analyzed for a given service step and construct a corresponding interaction type. Because user interactions are specific to the type of user that represents a type of participant that utilizes a type of service, users serve as the arbiter of what comprises an appropriate user interaction.

A service's tasks provide the user interaction necessary to feed the derivation function for the service. Therefore, there are two ways to look at its task model. The first is a backward chain from the required inputs. Starting from these inputs, one can proceed backwards to the user interaction required to generate them. Then one can proceed backward for each user interaction if they require prior user interactions. One can perform this process until he arrives at user interactions for which the user is prepared at the very beginning of a service. In practice, one may probably eschew this top-down model in favor of bottom-up user task modeling. However, constructing this backward chain after the fact serves two useful purposes. First, it validates the user task model. Second, it provides some guidance in the sequencing of user interface screens. If one assumes the goal of a screen is to acquire a coherent unit of input, they know that the screen may logically include the information necessary for the user to provide the input. So the last screen may provide the user a choice as well as the information from the previous tasks. Chaining backward, one can construct a pro forma screen sequence, as shown in FIG. 9.

Enabling the user interaction specified by each task may require a number of interactive elements. User task modeling to date has revealed six fundamental types of interactive elements. Each of these elements is an abstraction with multiple possible interface representations. Moreover, the underlying data behind each element type may require a database representation as well. The six elements are:

Insert. [Placeholder]

Overwrite. [Placeholder]

Delete. [Placeholder]

List Scroll. [Placeholder]

List Filter. [Placeholder]

Alert. [Placeholder]

Limiting the user interfaces to representations of these basic element types has a very important benefit. Because of the use of the model-view-Controller pattern for user interfaces, knowing the abstract types of user interface elements enables one to use a common controller implementation and common model base classes. By deciding on database typing conventions for each abstract type, one can also build the database View base classes. If one can create successful interfaces using this paradigm, one could even move to automatic generation of service infrastructure. The only development task would be choosing the interface representation and laying out the resulting widgets.

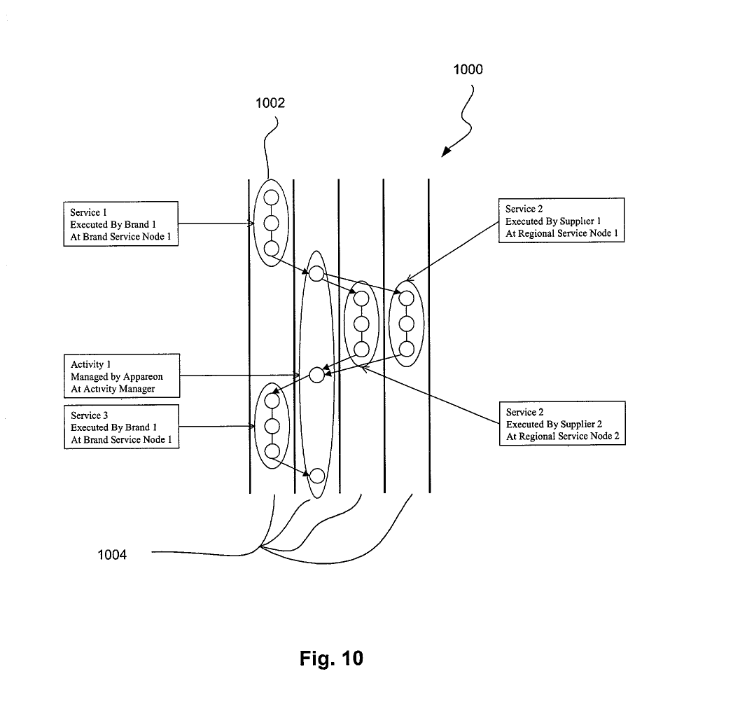

FIG. 10 illustrates a workflow model 1000 in accordance with one embodiment of the present invention. As shown, various services and activities 1002 may be carried out by different service centers 1004. Such service centers were set forth in detail hereinabove during reference to FIG. 6b.

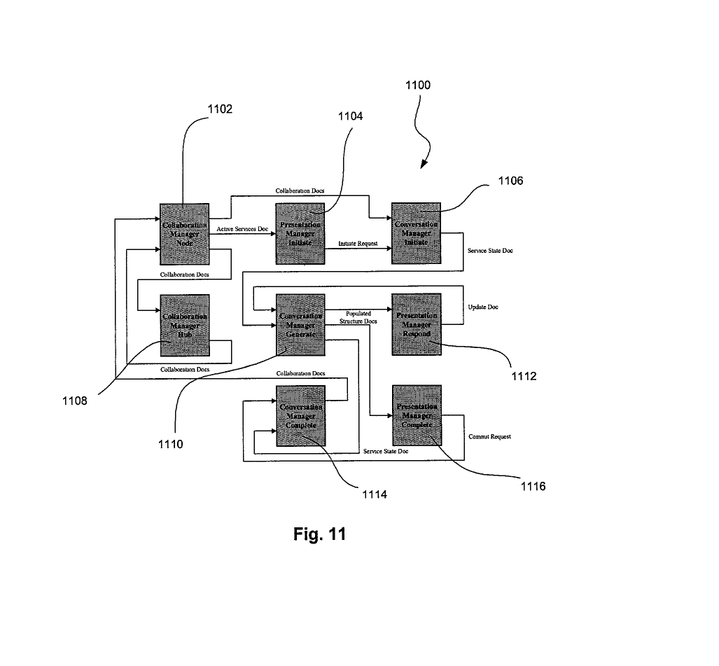

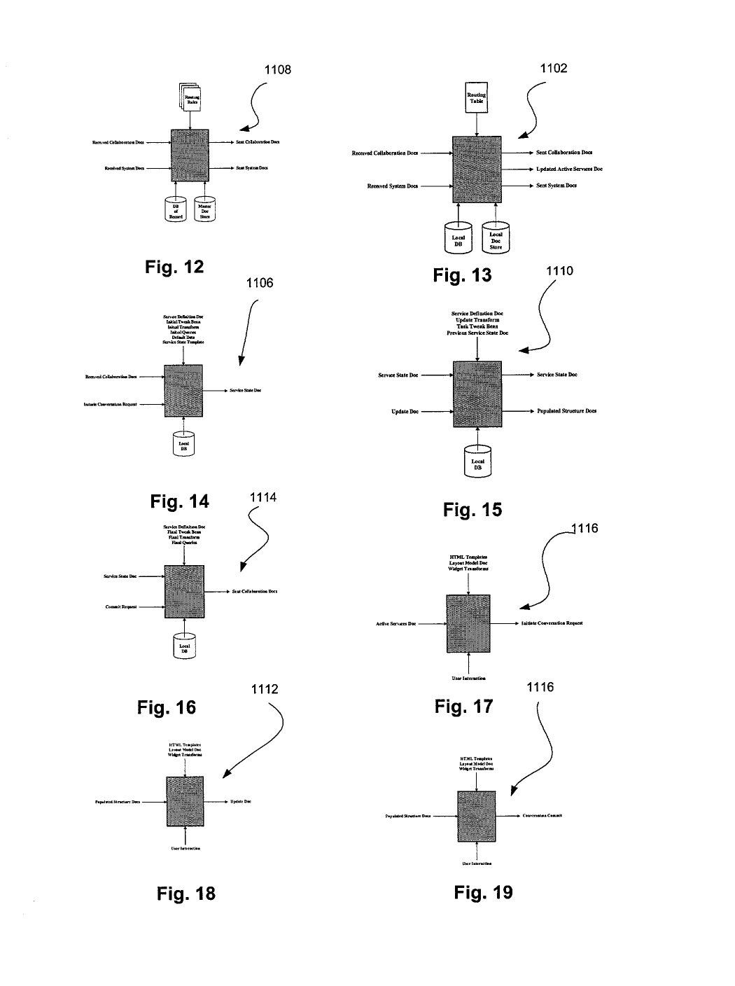

FIG. 11 illustrates a primary message flow 1100 among the various components of the present invention. As shown, information is distributed among a collaboration manager node 1102, a presentation manager initiate module 1104, a conversation manager initiate module 1106, a collaboration manager hub 1108, a conversation manager generate module 1110, a presentation manager respond module 1112, a conversation manager complete module 1114, and a presentation manager complete module 1116, the details of which will be set forth in greater detail during reference to FIGS. 12-19.

FIGS. 12-19 illustrate a collaboration manager hub 1108, collaboration manager node 1102, conversation manager initiate module 1106, conversation manager generate module 1110, conversation manager complete module 1114, presentation manager initiate module 1104, presentation manager respond module 1112, presentation manager complete module 1116, respectively. As shown, each of the components has certain predetermined input, output and accessible data.

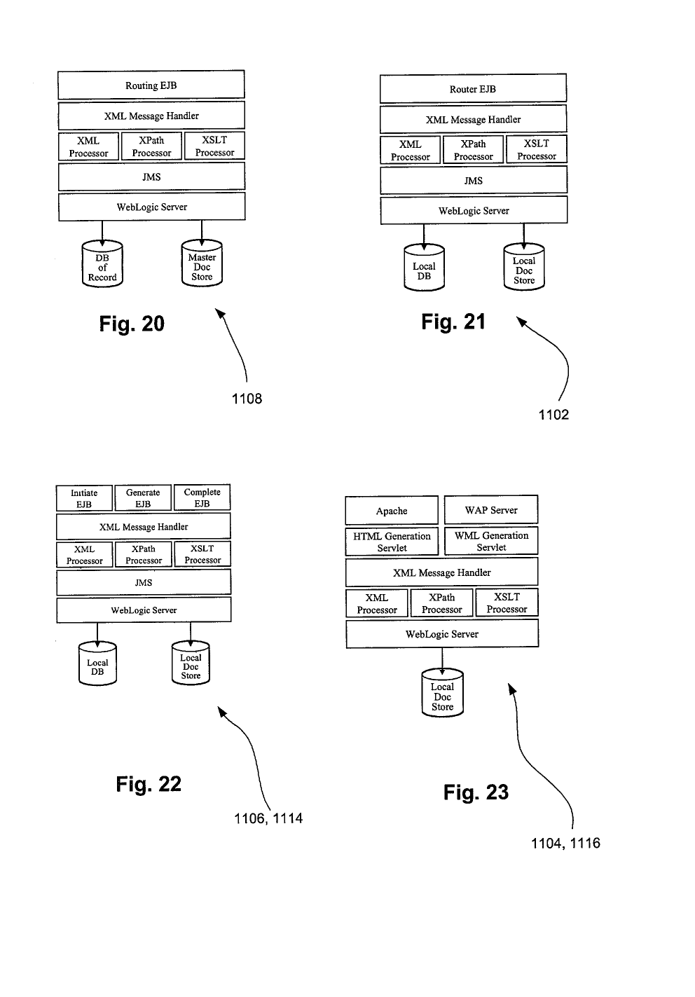

FIGS. 20-23 illustrate subsystem architectures associated with the collaboration manager hub 1108, collaboration manager node 1102, conversation manager modules 1106 and 1114, and presentation manager modules 1104 and 1116, respectively.

Security

The following are security measures that may be taken:

Hardened Hosts

Segmented Network

Link Encryption

Server-to-Server Certificate Authentication

User Password Authentication

Application-Level Access Control

Fully-Isolated Database of Record

| The following are encryption measures that may be taken: | |
|---|---|
| Server-to-Server: | 128-bit RC4 SSL |
| Client-to-Server: | 128-bit RC4 SSL (if legal) |
| | 64-bit RC4 SSL (otherwise) |

| The following are authentication measures that may be taken: | |
|---|---|
| Server-to-Server: | Mutual Certificates |
| Server-to-Client: | Server Certificate |
| | Client Password (default) |
| | Client Certificate (optional) |
| | IP Subnet (optional) |

The following are user action measures that may be taken:

Role-Based

Restricted Access to Services

Can only access services available to assigned role

Different service types can provide different levels of access to business document information

Managers can access employee work in progress (optional)

No Direct Access to Database

The following are host access measures that may be taken:

No External Administrative Access to Hosts

App Servers Accessible Only to Web Servers

Database Accessible only to App Servers

The explosion of Internet marketplace exchanges signals a transformation in the procurement landscape across every industry. The huge IPO valuations these exchanges have achieved has produced a land grab on the part of the new entrants who are seeking to change the procurement game, and also by the incumbents who are determined to halt disintermediation of their supply chains.

The retail industry is no stranger to these trends—more than 30 retail exchanges have emerged already across multiple retail segments. Though none are yet open for business on the Web, the early exchanges include Global Net Xchange, an alliance of Sears Carrefour, Sainsbury's and Metro; World Wide Retail Exchange with 16 equal members including Target, Arhold and CVS among others; and Apparel Buying Network, sponsored by Guess, Inc., to name just a few.

But despite the early excitement around marketplace exchange valuations and potential for value creation, market watchers are beginning to doubt the ability of these marketplaces to deliver on their initial promise, as shown by the precipitous decline in the stock values of a number of independent marketplace providers (exhibit 2). For many, the big question remains—do marketplace exchanges create new value as a result of revolutionizing the way retailers and suppliers do business together?

It is believed there may be only rags for marketplaces that try simply to reduce purchasing costs through aggregation but that the riches may exist for those retailers that through retail exchanges find ways to selectively e-enable and optimize their supply chains. In retail B2B marketplaces, one can expect the winners may be those who focus not just on aggregation opportunities who go beyond to reduce their total cost of ownership and overcome existing “pain points” in the retail supply chain. The simple reduction of cost of goods sold, which has been demonstrated in more commodity-oriented industries, may emerge in the short-term, however the most significant value may be created elsewhere in the medium to long term.

In retail, the challenges of taking B2B marketplace-exchanges from concept to reality are significant and the case is unproven. It is noteworthy that no consortium exchange has yet to launch a single functionality. It is perceived that five key challenges may be overcome to succeed with marketplace exchanges:

1. Achieving the necessary liquidity and scale required to be a credible marketplace.

2. Developing an ownership structure that may induce retail members to participate and invest in exchange development. Retailers may expect ownership for participation as charter members.

3. Accommodating multiple complex buying processes that vary across categories and retail formats. Retail terms by category may change significantly making the development of standards-based exchanges yet more intricate. Answering the apparently simple question of how a single purchase order may be formatted is in itself a challenge of co-ordination across retailers and categories.

4. Combining existing retailer technologies—be these transactional systems, merchandise planning or replenishment systems—of multiple exchange members with new e-enabling technologies from multiple providers in a standardized format. Once basic transactions have been completed, these transactions may be processed, often on separate application software and systems. Exchanges may need to develop a broad suite of options that can interface with multiple types of legacy retail systems.

5. Managing the privacy requirements and competitive conflicts that exist between exchange members of varying scales. For example, larger members may not be paying to share the advantages of their purchasing scale in basic items with smaller competitors. Yet they may be looking to gain the supply-chain benefits that result from improved collaboration and accelerated supply chain.

Despite these challenges, there are a number of reasons to believe that, ultimately, the value of retail B2B marketplaces may be significant and could translate to as much as 5-10% in sales increases, 5-10% of total systems costs reduction and a 20-30% reduction in inventory levels. First, e-enabling trade between suppliers and retailers to enhance chain visibility and streamline activities across the system can have many top line and bottom line benefits. Second, the underlying fundamentals of the business are sound across different categories. Third, retailers of all sizes and formats can gain value from exchanges depending on what key supply chain issues exist. Each of these rationales in turn may be explored.

The first reason to believe the underlying fundamentals of the exchange business are sound is that there are many benefits in e-enabling trade between supplier and retailer. These benefits include:

1. At the simplest level allowing retailers to participate in aggregated purchases where they are subscale—particularly in indirect cost buckets and basic product categories. Imagine the potential that may exist to aggregate health benefits or utility expenses for the US members of the World Wide Retail Exchange with their >1.4 million employees.

2. Giving retailers access to expiring capacity—particularly in perishable categories where grocers, for example, may have the opportunity to make spot special buys to deliver exceptional values to their customers through having improved market transparency. Conversely, retailers may also have the opportunity to use exchanges as efficient off-price dumping grounds for items that have not sold.

3. Providing retailers with a more immediate and liquid market to off-load surplus inventory of product.

4. Reducing broad based supply chain expenses as a result of both increased transparency and the application of new functionality. Exhibit 3 shows that these potential benefits exist throughout the buying cycle. Ultimately, retailers can expect to:

Improve the management of a dynamic and changing global sourcing strategy as labor rates, import quotas and exchange rates fluctuate across markets.

Reduce markdown rates through shortening manufacturing and supply chain lead times through increased on-line coordination between retailers and suppliers in a world where retailers compete to bring fashion goods to market quickly. A number of the third party marketplaces such as Retail.com and Trade4retail have already developed collaborative design modules for their apparel members. This approach however, may be equally valid in the development of hard-line categories involving design such as patio furniture.

Monitor the flow of goods through the logistics system.

Reduce actual costs of transactions. In the longer term, it is possible to imagine that retailers may not need to transmit any data to their suppliers and may share data through a hosted and secure website where information is visible to both merchant and supplier.

Link to replenishment systems to improve out-of stock positions more rapidly.

Many supply chain benefits may be incurred by net-enabling the design-to-order supply chains like the apparel industry's. Some of these benefits include reducing vendor overhead through a more efficient transaction process, reducing sample costs from improved shared design capabilities, reducing in-store handling from fewer missed shipping dates and the resulting doubling up of in-store sets and product handling of similar goods and finally, reduced inventory holding cost as a result of reduced safety levels in the system reflecting increased confidence in the availability of product and on its position in the supply chain.

Second, the underlying fundamentals of the exchange business are believed to be sound across all types of categories—fashion, basics, perishables and indirects. For fashion items, fashion basics, and in-and-out items that are more difficult to forecast, retailers may look for opportunities to accelerate and streamline their supply chains. In basic categories, such as denim and tees, apparel retailers with more predictable supply chain and forecast requirements may likely seek to maintain their scale benefits and not participate in open marketplaces. However, in these categories it may be possible to look for aggregation opportunities further up the supply chain by developing raw buying consortiums for their suppliers for basic fabrics and raw materials. In perishable categories, suppliers and retailers may be able to trade more swiftly in expiring products. In indirect categories, such as shopping carts, utilities and cleaning services, retailers may seek opportunities to bundle these services and identify new suppliers at reduced costs. This may be particularly true of sub-scale and regional retailers who may likely be able to aggregate their buying. In addition, the emergence of new trading categories, such as grocery end-caps and promotional space in weekly and in-store circulars, are anticipated.

The third reason to believe the underlying fundamentals of the exchange business are sound is that all retailers no matter their scale or format structure can create value from an exchange. While the scale of the retail partner may dictate what value may be created for that retailer, all retailers may want to participate. Smaller retailers may look to piggyback the scale of larger retailers in their category for basic purchasing economies. Medium to large retailers, by contrast, may be more selective in where they look to acquire scale for aggregation purposes and may more actively look to reduce markdown rates and out of stocks by accelerating and streamlining their supply chains through collaborative behavior with their supply base.

In categories in which retailers have scale, retailers may be reluctant to aggregate their buys. These retailers may be searching for pathways to become more nimble and faster to market, especially with fashion and perishable merchandise.

Success in creating value may not come easily given the challenges of building exchanges for the retail sector. Maximizing the potential upside may require the application of five basic principles:

1. Retailers may need to move beyond viewing exchanges as centers for transactions and seek to pull all levers associated with the total cost of ownership for procurement, including demand management, collaborative design, inventory management and supply chain visibility. After attempting to pull all levers, retailers can restructure their supply chains where appropriate.

2. Retailers may need to make focused commitments rather than multiple bets. The importance of marketplace liquidity through the aggregation of not just spend but manufacturing capacity and procurement capabilities may require that early entrants drive success through focus. Retailers may likely find it difficult to fragment their buy across categories given tolling fees associated with conducting trade through multiple exchanges.

3. Retailers may need to actively involve themselves in the development of electronic standards development for their retail segment, synchronizing detailed product, price and promotion information among trading partners. Tracking trade allowances may be a formidable part of developing an effective exchange. In the grocery arena, UCCNet is leading this challenge.

4. Retailers should anticipate that building a successful model may require investment not only in systems, but also in the best technology and merchandise talent available to guide service development.

5. Finally, it may be important to score early wins to maintain credibility and momentum with members and the marketplace. These early wins may be achieved by identifying the components of the supply chain that offer the greatest performance improvement both in the short term and long-term.

The retail procurement landscape is rapidly changing, creating new opportunities for suppliers and retailers to collaborate. Although these opportunities are yet to be proven, it is believed that significant value may be created as a result of improved supply-chain visibility and effectiveness with the tip of the iceberg emerging through purchase aggregation and surplus auction. First though, a myriad of execution and organizational challenges exist related to the opportunity capture. For retailers, participation is unavoidable in the continual race to optimize the business, and the key question may be not when but how.

Appendix A is an exemplary portion of an international glossary for an apparel vertical market that can be used to make the internal machine translation engine accurate for the apparel vertical.

APPENDIX A

| | | |
|---|---|---|
| 1. | @ | At (referring to price) |
| 2. | A. & C.P. | Anchors and chains proved |
| 3. | a.a. | Always afloat, after arrival |
| 4. | A.A.D. | Annual aggregate deductible |
| 5. | a.a.r. | Against all risks |
| 6. | AAAA | Always Afloat Always Accessible |
| 7. | AADFI | Association of African Development Finance Institutions |
| 8. | AAEI | American Association of Exporters and Importers |
| 9. | AAIB | Arab-African International Bank |
| 10. | AAPA | the American Association of Port Authorities |
| 11. | AARA | Amsterdam-Antwerpen-Rotterdam Area |
| 12. | AATPO | Association of African Trade Promotion Organizations |
| 13. | AA3311/100 | Aiale U.S.A.'s ™ for a polymide/polyster/elastone-double-face fabric. It is |
| | | breathable, water resistant used for pants and jackets. |
| 14. | 3 × 2 stretch rib | DuPont ™ constructed of 89% Supplex nylon and 11% Lycra. The design, feel |
| | | and texture closely match a ribbed T-shirt. |
| 15. | aba | A woven fabric derived from the hair of camels or goats. A traditional |
| | | sleeveless outer garment that is worn by men in the Middle East. |
| 16. | Abaca | A vegetable leaf fibre derived from the Musa textilis plant that is grown in the |
| | | Philippines but is also found in Africa, Malaysia, Indonesia and Costa Rica. The |
| | | fibre is obtained from the outer layer of the leaf and processed by separated |
| | | mechanically decorticated into lengths varying 3 to 9 feet. Resistant to salt |
| | | water and used for cordage. |
| 17. | Abaya | (Arabic) rectangular cloak without set-in sleeves |
| 18. | Abba | (Arabic) overcoat of straight cut with elbow-length sleeves |
| 19. | Abrash | The tonal variations in the fibers, usually the result of small-batch dyeing or the |
| | | use of wool dyed in different batches. As collectors consider this a desirable |
| | | characteristic, many large manufacturers of carpets and rugs have abrash |
| | | deliberately inserted in their products. |
| 20. | Abrasion | The effect of garments scrubbing against each other while in the dyebath. It |
| | | gives the material an aged look. In some processes this is desired (c.g. |
| | | Pigments), while in others, a great deal of effort goes into minimizing this |
| | | effect. |
| 21. | Abrasion test | A test used to simulate and measure the wear performance of warp and weft |
| | | yarns. The test determines the ability of a fiber or fabric to withstand wear, |
| | | rubbing, chafing and other friction forces. |
| 22. | Absorbency | The ability of a fabric to take in moisture. Absorbency is a very important |
| | | property, which effects many other characteristics such as skin comfort, static |
| | | build-up, shrinkage, stain removal, water repellency, and wrinkle recovery. |
| 23. | Acanthus | A motif or conventional representation of the leaf of an acanthus plant. Often |
| | | seen as large and scroll-like in appearance. |
| 24. | Accessories | Items such as shoes, scarves, stockings, purses, jewelry and hats that coordinate |
| | | and enhance the appearance of the person and the fashion garments. |
| 25. | accuvent | Proprietary non-film laminate from Enterprise Coatings; features controlled air |
| | | permeability that allows 25 to 30 CFM of wind penetration for high |
| | | breathability and quicker drying time. |
| 26. | Acele ® | Dupont ™ for acetate fiber. |
| 27. | Acetate | The generic name for a cellulose base, man made fiber.The first commercial |
| | | production of acrylic fiber in the United States was in 1924 by the Celanese |
| | | Corporation. |
| 28. | Acetone soluble | (acetate) when the hydrolysis of primary cellulose ethanoate (acetate) is allowed |
| | cellulose ethanoate | to proceed until approximately 54% of combined ethanoic (acetate) acid |
| | | remains in the product, the cellulose acetate is soluble in propanone (acetone) |
| | | and is sometimes known as acetone-soluble cellulose acetate. |
| 29. | Acetylation | The process of introducing an ethanoyl (acetyl) radical into an organic |
| | | molecule. |
| 30. | Acid dyes | An anionic dye applied from an acidic or neutral dye bath. It has affinity to |
| | | fibres containing basic groups. |
| 31. | acrilan | (trademark) used for an acrylic fiber. |
| 32. | acrylic fiber | A fast-drying synthetic textile fiber that is usually manufactured by |
| | | polymerization of acrylonitrile usually with other monomers. The first |
| | | commercial production of acrylic fiber in the United States was in 1950 by E.I. |
| | | du Pont de Nemours & Company, Inc. |
| 33. | Acrylonitrile | A tough rigid plastic. Used for making plastic heels on shoes. |
| 34. | Actif | Tapetex ™ for nylon/Lycra fabric used for jacket inserts, shorts and pants. |
| 35. | Activewear | A term that describes fabrics and apparel that have been designed to meet the |
| | | needs of active people. Some of the materials and treatments include |
| | | antimicrobial wicking polyolefin, water-resistant, titanium particles for |
| | | ultraviolet protection, abrasion-resistant fabrics, polyester microfiber, |
| | | antibacterial, antifungal acrylics, knitted polyester, and thermal fabrics; found in |
| | | fleece, interlock, jersey, bunting, pique, crepe mesh and ribs. |
| 36. | Adaptations | Designs that have all the major features of a certain original, but are not exact |
| | | copies. |
| 37. | Adsorption | Refers to the adhesion (like a glue) of a gas or liquid to the surface of a material |
| 38. | Adventure twill | Trademark from Tapetex for 70-denier cationic polyester and 70-denier Supplex |
| | | nylon for active outdoor apparel. |
| 39. | Aeration | A knitting operation that allows fabrics to breathe, often utilized in pantyhose |
| | | for cotton crotch panels or cotton soles. |
| 40. | Aerologic | Trademark of Dyersburg's 100-percent microdenier polyester single-sided fleece |
| | | for windproof, breathable laminates; for outerwear and accessories. |
| 41. | Aerophane | A filmuy transparent fabric often used for oversleeves or modesty inserts. |
| 42. | Aero-spacer dri-lex | Trademark for Faytex's liner fabric for footwear and backpack pads, made of |
| | | Allied Hydrofil nylon, polyester and monofilament moisture transport fiber. |
| 43. | Aesthetics | Refers to the appearance of the thread in the fmished seam that cam be affected |
| | | by contrast stitching, color matching, the sheen of the thread and the size of the |
| | | thread. |
| 44. | Affinity | The quantitative expression of substantivity. It is the difference between the |
| | | chemical potential of the dye in its standard state in the fibre and the |
| | | corresponding chemical -potential in the dyebath. |
| 45. | Afgaline | A plain weave, all purpose dress cloth, constructed using a woolen warp and |
| | | weft, or a worsted warp with a woolen weft. |
| 46. | afghan | A knitted or crocheted blanket or shawl that is designed in strips or squares |
| 47. | Afterwelt | The area of knitted fabric just below the double turned fabric in stockings. It is |
| | | usually made of the same yarn as the welt and is only one layer in thickness. |
| 48. | Agal | (Arabic) black tasseled cord which is wound around the head. |
| 49. | Agilon ® | ™ of Derring Milliken Inc. for textured Nylon. Agilon is often used in hosiery |
| | | and was one of the first stretch yarns used to make panty hose. |
| 50. | Agneline | a black woolen fabric with a very long nape. It is coarse and heavy. When |
| | | stretched the fibres tighten and become water resistant. |
| 51. | aiguillette | aglet; specifically, a shoulder cord worn by designated military aides [Compare |
| | | fourragère] |
| 52. | Airbrushing | The blowing of color onto a fabric with a mechanized airbrush. |
| 53. | Air entangled | Threads that have been made from continuous filaments that have been |
| | | entangled by high-pressure air as they run through an air jet. |
| 54. | Air laying | A method of forming a web (or batt) of staple fibres in which the fibres are |
| | | dispersed into an air stream and condensed from the air stream on to a |
| | | permeable cage or conveyor. |
| 55. | Air permeability | The degree to which a fabric, coating or laminate allows air to pass through its |
| | | construction |
| 56. | Air jet | A device used to bulk filament yarn be means of a pressure jet which throws the |
| | | filaments together devoid of any order so as to give a looped formation. It is |
| | | linked with the Taslan Process of E. I. DuPont de Nemours & Co., Inc., |
| | | Delaware. |
| 57. | Air aplice | A means of joining ends of yarn together using high pressure air. This produces |
| | | a union not as thick as a weaver's knots a better quality product is produced. |
| 58. | Ajour | An openwork design used in lace or embroidery with the pattern scattered on |
| | | the ground. |
| 59. | alb | a full-length white linen ecclesiastical vestment with long sleeves that is |
| | | gathered at the waist with a cincture |
| 60. | A la guillotine | A gown made entirely of scarlet fabric |
| 61. | Albatross | A soft lightweight fabric in plain weave, used in sheer dresses, blouses and |
| | | children's wear. The texture is fleecy and slightly napped. |
| 62. | Algerian eye stitch | Algerian eye stitch also goes by the names of Star stitch and Star eyelet stitch. |
| | | This stitch is often found on canvas work, pulled work and forms of counted |
| | | thread work. Worked on even weave fabric, it is made up of stitches arranged in |
| | | a square. |
| 63. | a-line | Triangular shaped skirt that is wider at the hem than at the waisband |
| 64. | AATT | (American Association for Textile Technology, Inc.) A national technical |
| | | society, whose members are qualified textile technologists engaged in |
| | | development work, research and testing in the fields of yarns, fibers, fabrics and |
| | | finishes. |
| 65. | AATCC | (American Association of Textile Chemists and Colorists) A nationwide |
| | | scientific body with active sections in various parts of the country, whose |
| | | members are chemists and others active in the dyeing, finishing and other |
| | | chemical phases of the industry. AATCC develops standards, test methods and |
| | | instruments for evaluating fabrics in the wet processing area of the industry. |
| 66. | Albert cloth | A cloth that has a double layer of wool and is reversible. Faces and backs may |
| | | vary in colour and pattern. Provides additional warmth and body. Used for |
| | | outerwraps. |
| 67. | ASTM | (American Society if Testing and Materials) An organization which sets up |
| | | standard methods of tests for textile and other merchandise. |
| 68. | ATMI | (American Textile Manufacturers Institute) Central trade association for the |
| | | fabric manufacturing industry. Serves as liaison between industry and |
| | | government. Compiles statistics on operations, imports, manufacturing and |
| | | technology. |
| 69. | alencon | an elegant needlepoint lace. |
| 70. | Alizarin dye | A vegetable dye originally obtained from the madder root. Used on cotton, |
| | | particularly in madder prints. It is now produced synthetically. |
| 71. | Alginate | First produced from seaweed in 1940. It is a product of a neutralizing reaction |
| | | between alginic acid and caustic soda. It is non-flammable. When combined |
| | | with other fibres, it takes on a sheer appearance. Used for gamishing, |
| | | camouflage and netting. |
| 72. | Alkali-cellulose | The product of the interaction of strong sodium hydroxide with purified |
| | | cellulose. |
| 73. | allover | A printed, embroidered, or lace fabric with a design covering most of the |
| | | surface such as a polka dot or foulard. |
| 74. | aloha | Shirt; a loose brightly colored Hawaiian sport shirt. |
| 75. | alpaca | True alpaca is a hair fiber taken from the Alpaca animal, a member of the llama |
| | | family of the South American Andes Mountains. The fiber contains much luster |
| | | and resembles mohair. Also imitated in wool, wool and alpaca, rayon, mohair |
| | | and rayon or cotton and a cotton warp and alpaca filling also synthetics - e.g. |
| | | Orion. It is a fine, strong and durable silk-like, soft, lightweight and warm |
| | | material. True alpaca is expensive so it is often combined with other fibres or |
| | | imitated by other fibres - e.g. orlon. If guard hairs are used it is inclined to be |
| | | boardy |
| 76. | Alpargata | A type of sandal made from woven cord |
| 77. | Alpha | A polyolefm fiber made by Amoco Fabric and Fibers Company, used for |
| | | thermal insulation in gloves, boots, jackets, hats and other winter/sports apparel. |
| | | Blended with cotton, Alpha turns denim into a high performance fabric for |
| | | rugged, all weather activities. |
| 78. | Alta micro | Collection of high performance fabrics from Summit Knitting Mills with |
| | | moisture management, soft hand, ease of care. Brushed and sueded finishes; for |
| | | performance wear. |
| 79. | Alta spun sport | Trademark of Summit Knitting Mills' fabric collection of CoolMax Alta low- |
| | | pill spun yarn, offering a natural touch, in a variety ofjacquard designs with |
| | | yarn dye styling techniques; for golf and athleisure apparel. |
| 80. | Alternating cross | Cross stitch is one of the oldest stitches in the world and many variations are |
| | stitch | practiced. It is used mainly on even-weave fabrics, where the threads can be |
| | | counted. Although the actual construction of cross stitch remains the same, |
| | | there are different methods of working. |
| 81. | amaranthine | the color of amaranth, i. e., red. |
| 82. | Amazon | Satin weave. Very soft. |
| 83. | amber | A variable color averaging a dark orange yellow. |
| 84. | Americana | A pattern often modeled on native paintings like those of Grandma Moses. |
| | | American shows rural landscapes and peaceful property. Popular with colonial |
| | | motifs, American Eagles, etc. |
| 85. | American Upland | The primary short staple variety grown in the U.S. representing the bulk of the |
| | Cotton | world crop, American Upland fiber runs between ¾″ and 1¼″. |
| 86. | amethyst | A variable color averaging a moderate purple. |
| 87. | Amersil | Venture Textile's™ proprietary silicone, fire-retardant coating offers tear- |
| | | resistance, superior waterproofness and flame retardancy; for tents, sleeping |
| | | bags, outerwear and activewear.e |
| 88. | AM Microstop | Antimicrobial, wicking polyolefin in a variety of constructions (e.g. with Lycra, |
| | | from Coville); a performance activewear applications. |
| 89. | Amphoteric | A property which means a chemical has a tendency to be nonionic at an alkalai |
| | | Ph and becomes more cationic as the Ph lowers to the acid side. |
| 90. | Ammana | Large wound turban worn by Muslim's. |
| 91. | Anaphe | A wild silk from the larvae of the Anaphe moth. |
| 92. | Anadem | (archaic) a wreath for the head, garland. |
| 93. | angora | (Goat/Rabbit) (Goat) a breed of goat that produces long silky hair known as |
| | | Mohair. The goat is native to Anatolia in the Angora province of Turkey but is |
| | | raised extensively today in Texas by ranchers. (Rabbit): Hair from the angora |
| | | rabbit. Often blended and mixed with wool to lower the price of the finished |
| | | article or to obtain fancy or novelty effects |
| 94. | Anidex | A generic term for an elastomeric fiber in which the fiber-forming substance is |
| | | any long chain synthetic polymer composed of at least fifty percent by weight |
| | | of one or more esters of amonohydric alcohol and acrylic acid. It gives |
| | | permanent stretch and recovery to fabrics and resists gas, oxygen, sunlight, |
| | | chlorine bleaches and oils. |
| 95. | Aniline dye | A term usually applied to any synthetic or organic dye. |
| 96. | Anim | Trademark of Robin and Haas Company for anidex fiber. |
| 97. | Animal skins | A pattern that represent primal, savage and exotic animals. These date from the |
| | | early 19^{th} century, when Napoleon brought back to Paris real hides collected on |
| | | his expedition to North Africa. |
| 98. | Anionic dye | A dye that dissociates in aqueous solution to give a negatively charged ion. |
| 99. | anklet | a short sock reaching slightly above the ankle |
| 100. | Anso-tex | Trademark by Allied Signal Performance Fibers for a high-tenacity Nylon. It |
| | | provides high strength and superior abrasion resistance, and dyes and prints |
| | | bright clean colors for footwear, outerwear, accessories, soft sided luggage, |
| | | duffle bags, sports bags and webbing. |
| 101. | anorak | [Chiefly British] parka anorak Usually identifying a pullover hooded jacket |
| | | long enough to cover the hips. |
| 102. | anthrax | A disease known as “woolsorters disease” that can be transmitted through |
| | | Mohair, Camel′s hair, Alpaca, and Cashmere. It localizes in the skin or lungs |
| | | and sometimes in the intestines. The symptoms are virulent ulcers and high |
| | | fever. Both men and animals are subject to this infectious disease. The disease |
| | | is not always fatal and when confined to skin alone, a cure is usually effected. |
| 103. | Antimigrant | A chemical added to the process compounds to stop dye from moving around |
| | | during processing. (see bleeding) |
| 104. | Antique lace | A heavy lace on a square knotted net with designs darned onto the net; the |
| | | machine lace is often used for curtains. |
| 105. | Antique satin | A sateen or horizontal sateen drapery fabric with horizontal (weft) slubs which |
| | | imitate spun shantung silk. It is composed of approximately 60% rayon (the |
| | | face of yarn fiber) and 40% acetate (the back yarn fiber). Occasionally, the warp |
| | | and weft yarns are dyed different colors to give an iridescent effect. |
| 106. | Antistatic | The build up of static electricity is a problem with many synthetic fibers. This |
| | | causes static electricity situations which shocks when touching metal while |
| | | wearing something that has built-up static electricity. Antistatic finishes are |
| | | used on fabrics of this type to cut down on or eliminate the problems, one of |
| | | which, not widely known is static electricity's affinity to dirt. |
| 107. | Antimicrobial | Describes a fiber which is treated to inhibit the growth of a broad spectrum of |
| | | bacteria, fungi and yeast. |
| 108. | Antron nylon ® | (™ DuPont) Trilobal Nylon. Antron combines lustre, strength, and coloration |
| | | properties and is most commonly used in the panty of some pantyhose styles to |
| | | give sheen. |
| 109. | Antung | Silk. a Chinese plain weave without slubs from the Antung region of China. |
| | | Made from wild silk. |
| 110. | Apparel | Clothing. |
| 111. | Apparel contractor | A business that supplies sewing services to the apparel industry. |
| 112. | Apparel jobber | Description of a business that is involved in garment manufacturing that handles |
| | | all aspects of garment making, including: designing, planning, cuffing, selling |
| | | and shipping. Everything except the actual sewing. |
| 113. | Apron | The canvas or cord which is attached to the cloth and warp beams and which is |
| | | long enough to reach the shafts. The apron has a wooden bar or metal rod for |
| | | attaching the warp threads. |
| 114. | Application | A numeric prefix to a UCC/EAN-128 code that defines the encoded data to |
| | identifier | follow. These are generally used as secondary codes to provide information not |
| | | included in standard U.P.C. numbering, such as product dates, weights and |
| | | lot/batch numbers. It may also identify a UCC serial shipping container code. |
| 115. | apparel | Personal attire; clothing, wardrobe. |
| 116. | Apparel jobber | In garment manufacturing, a business that handles all aspects of garment |
| | | making (designing, planning, cuffing, selling and shipping apparel) except for |
| | | the actual sewing. |
| 117. | Apparel wool | Broad term which embraces all wool except carpet and pulled wools. |
| 118. | Appliqué | A separate, pre-cut piece of fabric that is decorated (or decorated and then cut), |
| | | and applied to another piece of fabric, typically a garment. Frequently used to |
| | | reduce overall embroidery stitch counts, execute reproductions of which |
| | | embroidery is incapable (such as continuous-tone printing) and decorate |
| | | substrates difficult to embroider directly. |
| 119. | Appraisal | Subjective measureent of attributes of a line of wool based upon length, texture, |
| | | fineness, greasiness, obvious vegetable matter or colour. |
| 120. | Appraiser | Person who performs appraisal of wool. |
| 121. | apricot | a variable color averaging a mod orange. |
| 122. | apron | (1). A garment of cloth, plastic, or leather tied around the waist and used to |
| | | protect clothing or adorn a costume. 2. In looming equipment terms, the canvas |
| | | or cord which is attached to the cloth and warp beams and which is long enough |
| | | to reach the shafts. 3. The large fold of a Merino ram carried in front of the neck. |
| 123. | aqua | a light greenish blue. |
| 124. | Aquaforte | Klingler Textil's micro Tactel creates water-resistant, abrasion resistant fabrics |
| | | for outerwear and activewear. |
| 125. | Aquaguard | Trademark of Rotofil for waterproof/breathable film for technical outerwear |
| | | fabrics. |
| 126. | Aquamiracle | Trademark of Tomen for a Technofine back for wicking and Sunpaque face |
| | | containing titanium particles for ultraviolet protection, even when wet; for |
| | | activewear. |
| 127. | aquamarine | a pale blue to light greenish blue. |
| 128. | Aquator | Trademark from DuPont for Tactel nylon knit inside, cotton outside; moves |
| | | moisture away from skin to outside layer for evaporation; for active apparel |
| 129. | Arabesque | Decoration characterized by symmetrical intertwining branches, leaves and |
| | | other plant forms together with abstract curvilinear shapes. |
| 130. | Aramid | Generic name given by the F.T.C. in 1974 to a class of aramatic polyamide |
| | | fibers, Trade names of Nomex and Kevlar. Aramid is noted for its high |
| | | temperature and flame resistance qualities. |
| 131. | Architectural | A pattern/design that usually imparts a sense of a three-dimensional depth to an |
| | | architectural motif, whether it is or ornamental or not. |
| 132. | arctic | a rubber overshoe reaching to the ankle or above |
| 133. | Arctic fleece | Trademark from Menra Mills for lightweight polyester fleece for active outdoor |
| | | apparel. |
| 134. | Ardil | A fiber derived from protein in peanuts and made in England. A type of azlon. |
| 135. | argent | The heraldic color silver or white, whiteness. |
| 136. | Argentan lace | A lace similar to alencon, but the designs usually are not outlined with cord and |
| | | are often larger and bolder. |
| 137. | argyle | A sock knit in an argyle pattern, namely varicolored diamonds on a single |
| | | background color |
| 138. | armband | a band usually worn around the upper part of a sleeve for identification or in |
| | | mourning |
| 139. | armlet | a band, as of cloth or metal, worn around the upper arm |
| 140. | armor | defensive covering for the body, especially covering, as of metal, used in |
| | | combat |
| 141. | Armseye | (See “scye” arm hole of a garment. |
| 142. | armure | Fiber can be of cotton, silk, wool, rayon, synthetics, and blends. Embossing |
| | | effect used to give a pattern e.g. in drapery or upholstery. A dress fabric having |
| | | a wavy rib running in the weft direction which is produced by an amure weave. |
| | | giving a raised effect. Design is often in two colours and raised. The name was |
| | | derived from original fabric which was woven with a small interlaced design of |
| | | chain armor and used for military equipment during the Crusades. |
| 143. | Arnel | Trademark of Celanese Corp. for triacetate fiber. (See triacetate)> |
| 144. | Arrowhead | Used to reinforce and accent points of potential wear on clothing, such as the |
| | | tops of pleats. They are made with satin stitch and are triangular in shape. |
| 145. | Artificial silk | One of the first terms that described rayon. |
| 146. | art linen | Linen. Plain weave, It is woven with even threads that are especially good for |
| | | embroidery. It is very easy to “draw” the yarns for drawn thread work. Comes |
| | | bleached, or coloured. Has a soft finish. Its uses are all kinds of needlework, |
| | | lunch cloths and serviettes. |
| 147. | Art serge | A 2-up-2-down woven worsted which is fine in texture, piece-dyed in many |
| | | suitable colours, and used for draperies, table covers and general decorative |
| | | purposes. |
| 148. | Asbestos | A mineral fiber that is nonmetallic. Its greatest virtue is that it is nonflammable. |
| | | It is used in combination with other fibers for theater curtains and in industrial |
| | | clothing where flameproofing is essential. Also used for ironing board covers |
| | | and potholders. |
| 149. | ascot | A broad neck scarf, forerunner of the four-in-hand tie. Originally worn with |
| | | stick pin and wing collar shirt. It is now primarily worn with open neck sport |
| | | shirt as casual attire. Introduced at Ascot-Heath races in England. |
| 150. | ashen | resembling ashes (as in color). |
| 151. | Askewed or bias | A defect in fabric caused by filling yarns not square with warp yarns on woven |
| | | fabrics or where courses are not square with wale lines on knits. It can either be |
| | | major or minor due to the severity of the problem. |
| 152. | Aspirin dots | Popular circular designs, usually positioned in a regular pattern on the fabric, |
| | | although the placing may also appear random. Dots may be woven, knitted or |
| | | printed. Sizes usually determine the name of the dots. They are the size of |
| | | aspirin and often called polka dots. |
| 153. | astrakhan | A curled lustrous pile is the typical feature of this cloth, which imitates the |
| | | fleece of the stillborn or very young Astrakhan lamb. The effect may be |
| | | produced by weaving or knitting .It is sometimes made with a mohair warp to |
| | | add lustre and curl to the surface. Poor grades often have cotton warp or back. |
| | | The most popular shade is brown. |
| 154. | Astroturf | Trademark of Monsanto Company for its nylon product designed to imitate |
| | | grass. |
| 155. | Asymmetric | (knots) a type of know that may be tied to open right or open left, it also gives |
| | | the pile and inclination to right or left. |
| 156. | Atactic polymer | A linear polymer containing asymmetrically-substituted carbon atoms in the |
| | | repeating unit of the main chain, a planar projection of whose structure has the |
| | | same substituents situated randomly to any one side or the other of the main |
| | | chain (see also isotactic polymer and syndiotactic polymer). |
| 157. | Atelier | A studio or workroom where high-fashion garments are made. |
| 158. | Atmospheric | Since the temperature and relative humidity have an appreciable effect on the |
| | conditions, std. | physical properties of textiles, it is necessary that the conditions under which |
| | | samples are tested be rigidly controlled. In standard atmospheric conditions, the |
| | | moisture equilibrium must be maintained at a standard atmosphere having a |
| | | relative humidity of 65% (+/− 2%) and at 70 degrees plus/minus (2 degrees) |
| | | Fahrenheit (21 degrees C. +/− 1 degree. |
| 159. | auburn | a moderate brown. |
| 160. | Aubusson | Originally, Aubusson referred to tapestries made in Aubusson, France, that were |
| | | used as wall hangings. Later, the word was applied to patterned rugs with little |
| | | or slight rib and no pile. |
| 161. | Aubusson carpet | A term used for carpets made with a round wire and uncut looped pile to |
| | | distinguish them from cut pile carpets. |
| 162. | Aumoniere | A purse worn hanging from the belt during the 13^{th} century, usually, a small, |
| | | drawstring purse. |
| 163. | Austrian shade | A shade made of fabric which is shirred across the width of the shade. When |
| | | drawn up, Austrian shades hang in graceful loops of fabric. (see shirring). |
| 164. | Autoclaving | A process that involves placing bagged greige blanks in a large cylindrical |
| | | steam chamber that can be hermetically sealed. Once sealed, a vacuum system |
| | | is utilized to evacuate the air in the chamber. This in turn allows subsequent |
| | | attainment of stream pressure much higher than possible at atmospheric |
| | | conditions. The net result is that the undeveloped yarn in the greige leg blanks |
| | | permanently shrinks and that the knitted stitches are “set”. |
| 165. | Avalanche | Trademark from Mile High Textile for a two-and three-ply Supplex treated for |
| | | waterproof breathability for outerwear and streetwear.. |
| 166. | Avalite | Trademark for Mile High Textile's jet-dyed, two ply Supplex with Teflon HT |
| | | DWR and a hydro-philic film created for a lightweight, waterproof, breathable, |
| | | windproof outerwear fabric. |
| 167. | Avant-garde | (ah-vahnt-gahrd) new or experimental ideas in fashion designs, styles or use of |
| | | materials. |
| 168. | Avlin | ™ FMC Corporation for polyester. (see polyester). |
| 169. | avocado | a light yellowish green. |
| 170. | Avril | Trademark of FMC Corporation for high-wet modulus rayon. |
| 171. | Awasi | A good carpet combing wool from Mespotamia. |
| 172. | Awning stripe | Heavy, firm-woven cotton duck or canvas with either varn-dyed printed or |
| | | painted stripes. Used for awnings and beach umbrellas. |
| 173. | Axminster | Machine-made rug with oriental designs or velvet construction on an Axminster |
| | | loom. |
| 174. | Azlon | A generic name for manufactured fibers made from regenerated naturally |
| | | occurring proteins, such as casein, zein, soybean and peanut. It gives a soft |
| | | feeling when blended with other fibers. |
| 175. | Azoic-dye | (uh-zoh-ik dy) See napthol dye |
| 176. | azure | the blue color of the clear sky. |
| 177. | babushka | In Russia, a usually triangularly folded kerchief for the head. |

| | |
|---|---|
| d | Draught |
| D-RAM | Dynamic Random Access Memory |
| D.A.A. | Documents against acceptance |
| D.B. | Day Book, Deals and battens (timber trade) |
| d.b.b. | Deals, battens and boards |
| D.D. | Damage done |
| D.D.C. | Damage done in collision |
| D.D.E. | Direct data entry |
| d.d.o. | Despatch discharging only |
| D.F. | Direction finder or Dead Freight |
| d.l.o. | Dispatch loading only |
| d.p.r. | Daily pro rata |
| D.R.C. | Damaged received in collision |
| D.T.B.A. | Days to be agreed, date to be advised |
| D.T.I. | Department of Trade and Industry |
| d.w. | Deadweight (tons of 2,240 lbs.) |
| D.W.A.T. | Deadweight all told |
| d.w.c. | Deadweight capacity/Deadweight for cargo |
| d.w.t. | Deadweight tonnage |
| D/A | Deposit account, Days after acceptance, Documents against acceptance, |
| | Discharge afloat, Deductible average, Disbursement Account |
| D/C | Deviation clause |
| D/d | Days after date, Days' date |
| D/D | Demand Draft, Delivered at Docks, Damage Done |
| D/P | Documents against payment |
| D/s | Days after sight |
| D/V | Dual Valuation |
| D/W | Dock warrant |
| DA | Development Assistance |
| DAC | Development Assistance Committee |
| DACON | Data on Consulting Firms |
| DAEs | Dynamic Asian Economies |
| DAF | Delivered At Frontier |
| DANIDA | Danish International Development Assistance |
| DAP | Days All Purposes (Total days for loading and disch.) |
| DAT | Dangerous articles tariff. |
| Dbk. | Drawback |
| DC | Discharge Capacity |
| DCA | Department of Civil Aviation. |
| dd/s. | Delivered sound (grain trade) |
| DDP | Delivered duty paid. |
| DDU | Delivered duty unpaid. |
| Def. a/c | Deferred account |
| DEG | Deutsche Finanzierungsgesellschaft fur Beteilgungen in, |
| | EntwicklungsIndern GmbH |
| DEIP | Dairy Export Incentive Program |
| dely. and re-dely. | Delivery and re-delivery |
| DEM | DEMurrage |
| DEQ | Delivered ex quay/duty paid. |
| DESP | DESPatch |
| Det. | Detained |
| DF | Designated Federal Officer |
| DFA | Development Fund for Africa |
| Dft. | Draft |
| DGR | Dangerous Goods Requirement. |
| DHDATSBE | Despatch Half Demurrage on All Time Saved Both Ends |
| DHDWTSBE | Detpatch Half Demurrage on Working Time Saved Both Ends |

While the present invention has been described in terms of several preferred embodiments, there are many alterations, permutations, and equivalents that may fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A method for multilingual global editing utilizing a network, comprising the steps of:
(a) receiving text in a first language from a first user utilizing a network;
(b) translating the text from the first language to a second language;
(c) transmitting the translated text to the first user utilizing the network;
(d) allowing the first user to edit the translated text; and
(e) sending the edited, translated text to a second user utilizing the network.

2. The method as recited in claim 1, wherein the translated text is displayed to the first user on a display device for the allowing the first user to edit the translated text.

3. The method as recited in claim 2, wherein a virtual keyboard is displayed to the first user on a display device for the allowing the first user to edit the translated text.

4. The method as recited in claim 3, wherein the virtual keyboard includes alphanumeric characters in the second language.

5. The method as recited in claim 1, wherein the edited, translated text is saved.

6. The method as recited in claim 1, wherein the text relates to an apparel industry.

7. A computer program product for multilingual global editing utilizing a network, comprising:
(a) computer code for receiving text in a first language from a first user utilizing a network;
(b) computer code for translating the text from the first language to a second language;
(c) computer code for transmitting the translated text to the first user utilizing the network;
(d) computer code for allowing the first user to edit the translated text; and
(e) computer code for sending the edited, translated text to a second user utilizing the network.

8. The computer program product as recited in claim 7, wherein the translated text is displayed to the first user on a display device for the allowing the first user to edit the translated text.

9. The computer program product as recited in claim 8, wherein a virtual keyboard is displayed to the first user on a display device for the allowing the first user to edit the translated text.

10. The computer program product as recited in claim 9, wherein the virtual keyboard includes alphanumeric characters in the second language.

11. The computer program product as recited in claim 7, wherein the edited, translated text is saved.

12. The computer program product as recited in claim 7, wherein the text relates to an apparel industry.

13. A system for multilingual global editing utilizing a network, comprising:
(a) logic for receiving text in a first language from a first user utilizing a network;
(b) logic for translating the text from the first language to a second language;
(c) logic for transmitting the translated text to the first user utilizing the network;
(d) logic for allowing the first user to edit the translated text; and
(e) logic for sending the edited, translated text to a second user utilizing the network.

14. The system as recited in claim 13, wherein the translated text is displayed to the first user on a display device for the allowing the first user to edit the translated text.

15. The system as recited in claim 14, wherein a virtual keyboard is displayed to the first user on a display device for the allowing the first user to edit the translated text.

16. The system as recited in claim 15, wherein the virtual keyboard includes alphanumeric characters in the second language.

17. The system as recited in claim 13, wherein the edited, translated text is saved.

18. The system as recited in claim 13, wherein the text relates to an apparel industry.
